(19) United States
(12) Patent Application Publication
(10) Pub. No.: US 2026/0095858 A1
(43) Pub. Date: Apr. 2, 2026

(54) METHODS FOR MEASUREMENT ADJUSTMENT FOR LP-WUS

(71) Applicant: InterDigital Patent Holdings, Inc., Wilmington, DE (US)

(72) Inventors: Young Woo Kwak, Woodbury, NY (US); Moon IL Lee, Melville, NY (US); Virgil Comsa, Montreal (CA); Prasanna Herath, Laval (CA); Virgile Garcia, Antibes (FR)

(73) Assignee: InterDigital Patent Holdings, Inc., Wilmington, DE (US)

(21) Appl. No.: 18/901,969

(22) Filed: Sep. 30, 2024

(51) Int. Cl. H04W 52/02; H04L 5/00; H04W 68/00

(52) U.S. Cl. CPC H04W 52/0229; H04L 5/0048; H04W 68/005

(57) ABSTRACT

Methods, systems, and devices for monitoring low power wake-up signal (LP-WUS) are provided. A wireless transmit/receive unit (WTRU) comprising a low power radio (LR) and a main radio (MR) is provided. The WTRU receives configuration information indicative of one or more sets of adjustment values and a MR threshold. The WTRU identifies a LR bandwidth, a LR band, a MR bandwidth, and a MR band. The WTRU determines an alpha adjustment value based on a bandwidth ratio between the LR bandwidth and the MR bandwidth. The WTRU determines a delta adjustment value based on a band difference between the LR band and the MR band. The WTRU adjusts the MR threshold based on the alpha adjustment value and the delta adjustment value. The WTRU monitors the LP-WUS upon determining that a reference signal (RS) measurement for a RS exceeds the adjusted MR threshold.

### BACKGROUND

For reducing power consumption in wireless devices such as user equipment, wireless networks such as 5G and/or 6G etc. may use a low power-wake up signal (LP-WUS). The wireless devices may monitor the LP-WUS by using a low power radio (LR), and may trigger a main radio (MR) for data and/or signal transmission and/or reception. Since the LR consumes less power than the MR, using the LP-WUS may reduce power consumption in a wireless device.

However, conventional wireless devices lack efficient ways of determining time and duration of monitoring the LP-WUS. Further, since bands and/or bandwidths of the LR and the MR may be different, the wireless devices may attempt to monitor the LP-WUS even in areas that do not have LP-WUS coverage. This causes an increase in latency without providing any power saving.

### SUMMARY

In an embodiment of the present disclosure, a wireless transmit/receive unit (WTRU) is provided. The WTRU comprises at least one transceiver, a memory, and a processor. The at least one transceiver comprises a low power radio (LR) and a main radio (MR). The at least one transceiver is configured to receive configuration information indicative of a first set of adjustment values, a second set of adjustment values, and a MR threshold. The processor is configured to identify a LR bandwidth and a LR band associated with the LR. The processor is configured to identify a MR bandwidth and a MR band associated with the MR. The processor is configured to select an alpha adjustment value from the first set of adjustment values based on a bandwidth ratio between the LR bandwidth and the MR bandwidth. The processor is configured to select a delta adjustment value from the second set of adjustment values based on a band difference between the LR band and the MR band. The processor is configured to modify the MR threshold based on the alpha adjustment value and the delta adjustment value to determine an adjusted MR threshold. The processor is configured to determine that a reference signal (RS) measurement for at least one RS exceeds the adjusted MR threshold. The transceiver is configured to monitor a low power (LP)-wakeup signal (WUS) using the LR based on the determination.

In an embodiment of the present disclosure, a method for use in a WTRU is provided. The method includes receiving configuration information indicative of a first set of adjustment values, a second set of adjustment values, and a MR threshold. The method includes identifying a LR bandwidth and a LR band associated with the LR. The method includes identifying a MR bandwidth and a MR band associated with the MR. The method includes selecting an alpha adjustment value from the first set of adjustment values based on a bandwidth ratio between the LR bandwidth and the MR bandwidth. The method incudes selecting a delta adjustment value from the second set of adjustment values based on a band difference between the LR band and the MR band. The method includes modifying the MR threshold based on the alpha adjustment value and the delta adjustment value to determine an adjusted MR threshold. The method includes determining a RS measurement for at least one RS. The method includes, on a condition that the RS measurement exceeds the adjusted MR threshold, monitoring a LP-WUS using the LR. The method includes, on a condition that the RS measurement does not exceed or is equal to the adjusted MR threshold, monitoring one or more paging occasions (POs) for receiving one or more RSs.

In an embodiment, the WTRU monitors the one or more POs. The WTRU receives the one or more RSs including the at least one RS in the one or more POs.

In an embodiment, on the condition that the RS measurement exceeds the adjusted MR threshold, the WTRU deactivates monitoring the one or more POs.

In an embodiment, the configuration information is further indicative of an LR threshold.

In an embodiment, the WTRU modifies the LR threshold based on the alpha adjustment value and the delta adjustment value to determine an adjusted LR threshold. The WTRU determines a LP-RS measurement for at least one LP-RS. On a condition that the LP-RS measurement exceeds the adjusted LR threshold, the WTRU deactivates monitoring the LP-WUS and monitors the one or more POs.

In an embodiment, the WTRU modifies the RS measurement based on the alpha adjustment value and the delta adjustment value to determine an adjusted RS measurement. On a condition that the adjusted RS measurement exceeds the MR threshold, the WTRU monitors the LP-WUS using the LR.

In an embodiment, the WTRU modifies the LP-RS measurement based on the alpha adjustment value and the delta adjustment value to determine an adjusted LP-RS measurement. On a condition that the adjusted LP RS measurement exceeds the LR threshold, the WTRU deactivates monitoring the LP-WUS and monitors the one or more POs.

In an embodiment, at least one of the LP-RS measurement or the RS measurement comprises one or more of: a RS received power (RSRP) or a LP-RSRP, a RS received quality (RSRQ) or a LP-RSRQ, a RS received strength indicator (RSSI) or a LP-RSSI, a synchronization signal (SS) or a LP-SS, or a preamble of the LP-WUS.

In an embodiment, the alpha adjustment value is zero when the LR bandwidth and the MR bandwidth are same.

In an embodiment, the delta adjustment value is zero when the band difference between the LR band and the MR band is less than a band difference threshold.

In an embodiment, at least one of the alpha adjustment value or the delta adjustment value is measured on a decibel (dB) scale.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example WTRU receiver according to one or more embodiments;

FIG. 3 illustrates an example idle mode wake-up signal according to one or more embodiments;

FIG. 4A illustrates an example WTRU power consumption in idle mode and/or inactive mode;

FIG. 4B illustrates an example WTRU power consumption using a paging early indication (PEI) to indicate whether the WTRU is paged;

FIG. 4C illustrates an example WTRU power consumption including a PEI and a tracking reference signal (TRS) availability; and

FIG. 5 is a flowchart illustrating an example process for monitoring the low power wake-up signal (LP-WUS) according to one or more embodiments.

### DETAILED DESCRIPTION

As discussed herein, one or more abbreviations in the following (non-exhaustive) list may be used herein.

TABLE 1

| | |
|---|---|
| Δf | Sub-carrier spacing |
| gNB | NR NodeB |
| ACK | Acknowledgement |
| AP | Aperiodic |
| BFR | Beam Failure Recovery |
| BFD-RS | Beam Failure Detection-Reference Signal |
| BLER | Block Error Rate |
| BWP | Bandwidth Part |
| CA | Carrier Aggregation |
| CAPC | Channel access priority class |
| CB | Contention-Based (e.g. access, channel, resource) |
| CCA | Clear Channel Assessment |
| CCE | Control Channel Element |
| CDM | Code Division Multiplexing |
| CE | Control Element |
| CG | Configured grant or cell group |
| CLI | Cross-Link Interference |
| CoMP | Coordinated Multi-Point transmission/reception |
| COT | Channel Occupancy Time |
| CP | Cyclic Prefix |
| CPE | Common Phase Error |
| CP-OFDM | Conventional OFDM (relying on cyclic prefix) |
| CQI | Channel Quality Indicator |
| CMAS | Commercial Mobile Alert System |
| CN | Core Network (e.g. LTE packet core or NR core) |
| CRC | Cyclic Redundancy Check |
| CSI | Channel State Information |
| CSI-RS | Channel State Information-Reference Signal |
| CU | Central Unit |
| CW | Contention Window |
| CWS | Contention Window Size |
| CO | Channel Occupancy |
| D2D | Device to Device transmissions (e.g. LTE Sidelink) |
| DAI | Downlink Assignment Index |
| DC | Dual Connectivity |
| DCI | Downlink Control Information |
| DFI | Downlink feedback information |
| DG | Dynamic grant |
| DL | Downlink |
| DM-RS | Demodulation Reference Signal |
| DRB | Data Radio Bearer |
| DRX | Discontinuous reception |
| DU | Distributed Unit |
| EN-DC | E-UTRA - NR Dual Connectivity |
| EPC | Evolved Packet Core |
| ETWS | Earthquake and Tsunami Warning Service |
| FD-CDM | Frequency Domain-Code Division Multiplexing |
| FDD | Frequency Division Duplexing |
| FDM | Frequency Division Multiplexing |
| FSK | Frequency Shift Keying |
| HARQ | Hybrid Automatic Repeat Request |
| ICI | Inter-Cell Interference |
| ICIC | Inter-Cell Interference Cancellation |
| IP | Internet Protocol |
| LAA | License Assisted Access |
| LBT | Listen-Before-Talk |
| LCH | Logical Channel |
| LCID | Logical Channel Identity |
| LCP | Logical Channel Prioritization |
| LLC | Low Latency Communications |
| LO | LP-WUS Occasion |
| LP-WUS | Low Power Wake-Up Signal |
| LP-WUR | Low Power Wake-Up Receiver |
| LTE | Long Term Evolution e.g. from 3GPP LTE R8 and up |
| MAC | Medium Access Control |
| MAC CE | Medium Access Control Control Element |
| NACK | Negative ACK |
| MBMS | Multimedia Broadcast Multicast System |
| MCG | Master Cell Group |
| MCS | Modulation and Coding Scheme |
| MIMO | Multiple Input Multiple Output |
| MO | LP-WUS Monitoring Occasion |
| MR | Main Radio |
| MTC | Machine-Type Communications |
| MR-DC | Multi-RAT Dual Connectivity |
| NAS | Non-Access Stratum |
| NCB-RS | New candidate beam-Reference Signal |
| NE-DC | NR -RAN - E-UTRA Dual Connectivity |
| NR | New Radio |
| NR-DC | Dual Connectivity with NR |
| OCC | Orthogonal Cover Code |
| OFDM | Orthogonal Frequency-Division Multiplexing |
| OFDMA | Orthogonal Frequency-Division Multiple Access |
| OOB | Out-Of-Band (emissions) |
| OOK | Orthogonal Frequency-Division Multiple Access |
| Pcmax | Total available UE power in a given transmission interval |
| Pcell | Primary cell of Master Cell Group |
| PCG | Primary Cell Group |
| PDU | Protocol Data Unit |
| PEI | Paging Early Indication |
| PER | Packet Error Rate |
| PHY | Physical Layer |
| PLMN | Public Land Mobile Network |
| PLR | Packet Loss Rate |
| PO | Paging Occasion |
| PRACH | Physical Random-Access Channel |
| PRB | Physical Resource Block |
| PRI | PUCCH Resource Indicator |
| PRS | Positioning Reference Signal |
| Pscell | Primary cell of a Secondary cell group |
| PSS | Primary Synchronization Signal |
| PT-RS | Phase Tracking-Reference Signal |
| QoS | Quality of Service (from the physical layer perspective) |
| RAB | Radio Access Bearer |
| RAN PA | Radio Access Network Paging Area |
| RACH | Random Access Channel (or procedure) |
| RAR | Random Access Response |
| RAT | Radio Access Technology |
| RB | Resource Block |
| RCU | Radio access network Central Unit |
| RF | Radio Front end |
| RE | Resource Element |
| RLF | Radio Link Failure |
| RLM | Radio Link Monitoring |
| RNTI | Radio Network Identifier |
| RO | Random Access Occasion |
| ROM | Read-Only Mode (for MBMS) |
| RRC | Radio Resource Control |
| RRM | Radio Resource Management |
| RS | Reference Signal |
| RSRP | Reference Signal Received Power |
| RSRQ | Reference Signal Received Quality |
| RTT | Round-Trip Time |
| SBFD | Subband non-overlapping full duplex |
| SCG | Secondary Cell Group |
| SCMA | Single Carrier Multiple Access |
| SCS | Sub-Carrier Spacing |
| SDU | Service Data Unit |
| SIB | System Information Block |
| SOM | Spectrum Operation Mode |
| SP | Semi-persistent |
| SpCell | Primary cell of a master or secondary cell group. |
| SRB | Signaling Radio Bearer |
| SS | Synchronization Signal |
| SRS | Sounding Reference Signal |
| SSS | Secondary Synchronization Signal |
| SUL | Supplementary UpLink |
| SWG | Switching Gap (in a self-contained subframe) |
| TB | Transport Block |
| TBS | Transport Block Size |
| TCI | Transmission Configuration Index |
| TDD | Time-Division Duplexing |
| TDM | Time-Division Multiplexing |
| TI | Time Interval (in integer multiple of one or more symbols) |
| TTI | Transmission Time Interval (in integer multiple of one or |
| | more symbols) |
| TRP | Transmission/Reception Point |
| TRPG | Transmission/Reception Point Group |
| TRS | Tracking Reference Signal |
| TRx | Transceiver |
| UL | Uplink |
| URC | Ultra-Reliable Communications |
| URLLC | Ultra-Reliable and Low Latency Communications |
| V2X | Vehicular communications |
| WLAN | Wireless Local Area Networks and related technologies |
| | (IEEE 802.xx domain) |
| WUS | Wake-up signal |
| XDD | Cross Division Duplex |

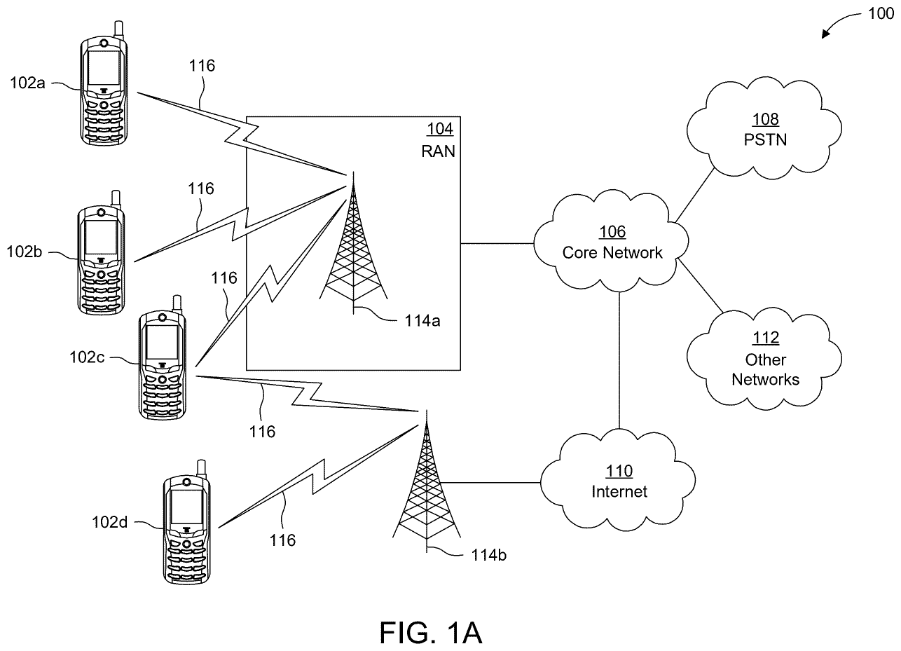

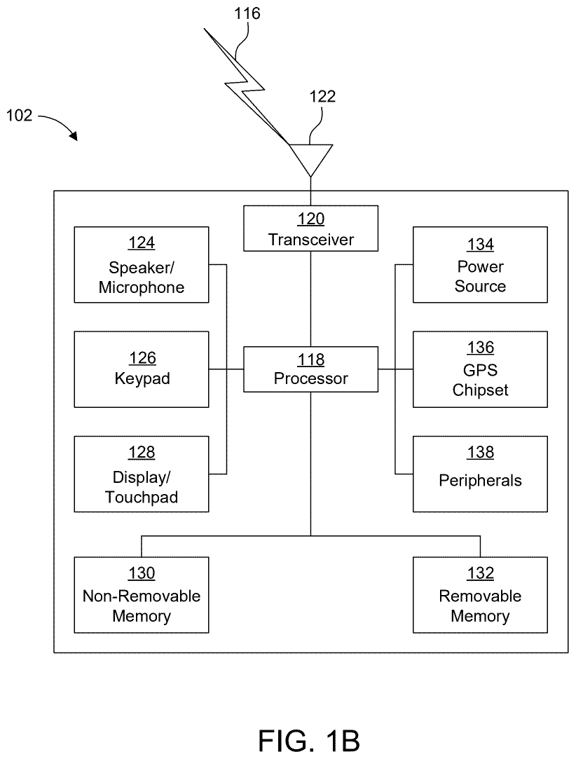

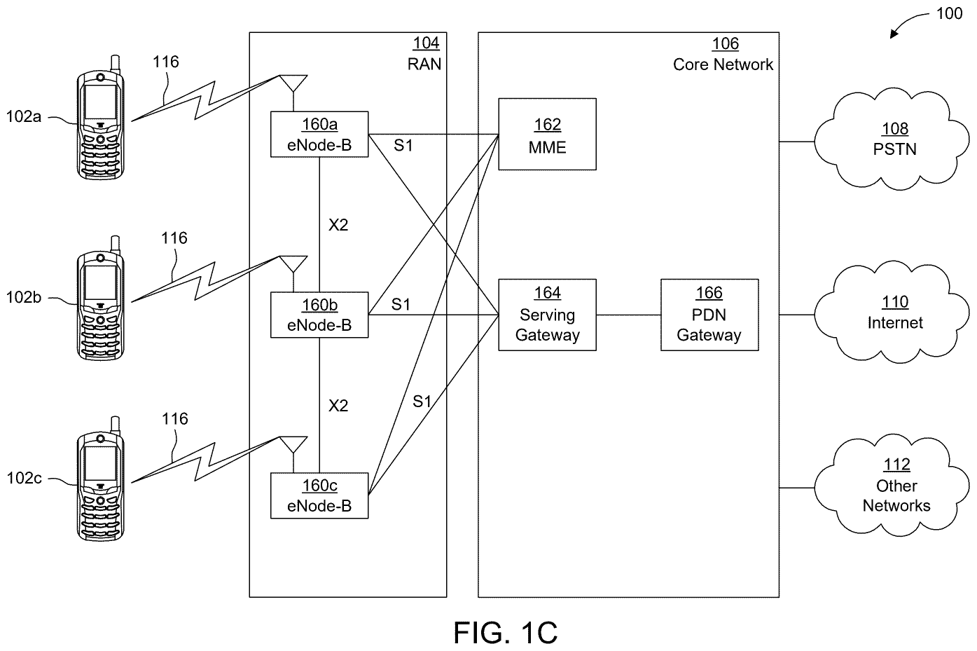

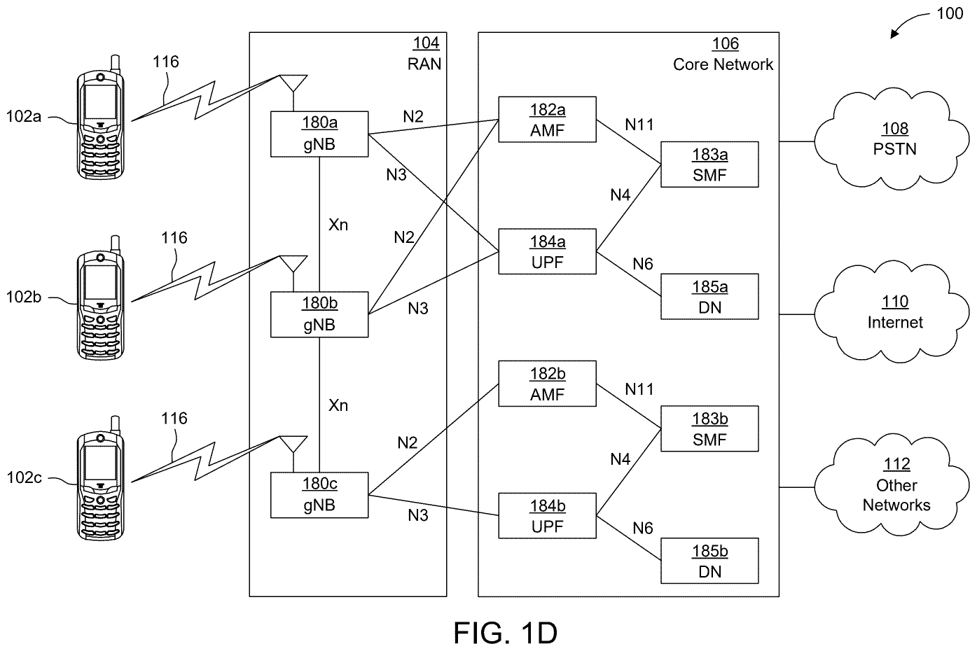

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

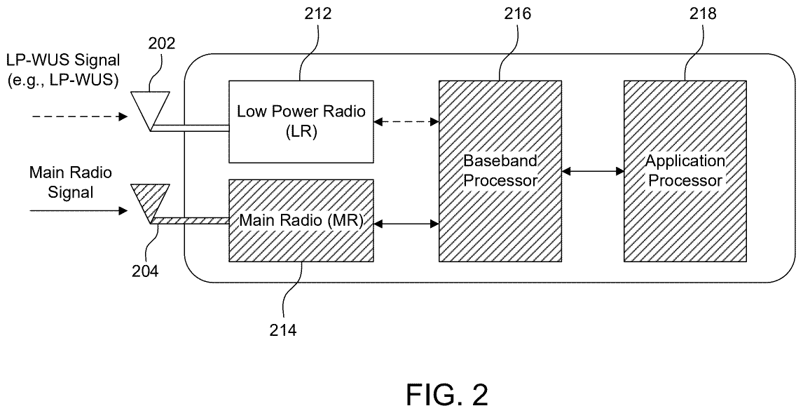

FIG. 2 illustrates an example WTRU receiver according to one or more embodiments. The WTRU receiver includes a low power antenna 202, a main antenna 204, a low power radio (LR) 212, a main radio (MR) 214, a baseband processor 216, and an application processor 218. A low power-wake up signal (LP-WUS) monitoring has a potential to reduce power consumption of the WTRU and other small battery powered devices. This is achieved by using a separate ultra-low power consumption receiver, e.g., the LR 212 which may monitor one or more wake-up signals (WUSs) such as the LP-WUS and trigger the MR 214 that is dedicated for data and control signal transmission and/or reception as shown in FIG. 1.

The LP-WUS and the MR 214 may utilize different bandwidths. Considering simple receiver architecture and low coverage of the LR 212, one or more bands supported by the LR 212 and/or one or more bandwidths available to the LR 212 may not be identical with the one or more bands supported by the MR 214 and/or the one or more bandwidths available to the MR 214. In this case, the WTRU procedures including entry and/or exit of monitoring the LP-WUS, i.e., LP-WUS monitoring, radio resource management (RRM) and/or radio link monitoring (RLM) measurement, offloading and/or wake-up delay for monitoring physical downlink control channel (PDCCH) may be inaccurate and/or adjustment may be needed to correct the measurement considering different bands between the MR 214 and the LR 212.

There may be a need of measurement adjustment for the LR 212 and/or the MR 214. An accurate channel measurement is important for the LP-WUS as the channel measurement is used for overall WTRU operation including one or more entry and/or exit conditions of the LP-WUS monitoring, the RRM and/or RLM measurement offloading from the MR 214 to the LR 212 and one or more neighboring cell measurement relaxation. In an example, if an inaccurate measurement is used for the one or more entry and/or exit conditions, the WTRU may activate the LP-WUS monitoring based on the inaccurate measurement and quickly deactivate the LP-WUS monitoring due to lack of LR coverage. In this case, utilization of the LR 212 provides increased latency due to activating and/or deactivating the MR 214 without any power saving gain.

Therefore, there is a need for a technique to adjust measurements of the LR 212 based on the difference in bandwidth and/or band with the MR 214.

In various embodiments of the present disclosure, the WTRU may determine one or more thresholds for the one or more entry and/or exit conditions for the LP-WUS monitoring based on a bandwidth ratio and/or a band difference between the MR and the LR. In more embodiments, the WTRU may determine one or more measured qualities associated with the one or more entry and/or exit conditions, the RRM and/or RLM and neighboring cell measurement relaxation based on the bandwidth ratio and the band difference between the MR and the LR.

In an example, the WTRU may determine an adjusted entry threshold and/or an adjusted quality of one or more measurements based on the bandwidth ratio and the band difference between a MR band and a LR band.

In that, the WTRU may receive (e.g., via system information block (SIB) etc.), configuration information (e.g., one or more configurations) related to the LP-WUS monitoring and/or paging, a WTRU identifier (ID), a number of total paging frames, a number of paging occasions (POs), a number of subgroups, a paging frame offset, one or more LP-WUS occasions (LOs) and one or more LP-WUS monitoring occasions (MOs) (e.g., based on offset between a paging frame and LO and/or MO), one or more reference signals (RSs) for LR measurement, one or more RSs for MR measurement (e.g., one or more synchronization signal blocks (SSBs) etc.), at least one MR threshold for at least one entry condition associated with the LP-WUS monitoring, at least one LR threshold for at least one exit condition associated with the LP-WUS monitoring, one or more candidate values for an alpha adjustment parameter (also simply referred to as “alpha”) wherein each candidate value is associated with a bandwidth ratio (e.g., the ratio of bandwidth of MR/bandwidth of LR), and/or one or more candidate values for a delta adjustment parameter (also simply referred to as “delta”) wherein each candidate value is associated with a band difference.

The WTRU may identify one or more band parameters related to the MR and/or the LR, respectively. Examples of the one or more band parameters include but are not limited to the band, a carrier frequency, and/or the bandwidth etc.

The WTRU may determine an adjusted entry threshold associated with the LP-WUS monitoring based on the one or more identified band parameters.

In various examples,

$$Adjusted entry threshold = Configured entry threshold + Alpha * Delta \qquad equation ( 1 )$$

$$Adjusted entry threshold = Alpha * ( Configured entry threshold + Delta ) \qquad equation ( 2 )$$

$$Adjusted entry threshold = Configured entry threshold + Alpha + Delta \qquad equation ( 3 )$$

$$Adjusted entry threshold = alpha * configured entry threshold \qquad equation ( 4 )$$

$$Adjusted entry threshold = alpha + configured entry threshold \qquad equation ( 5 )$$

$$Adjusted entry threshold = Configured entry threshold + Delta \qquad equation ( 6 )$$

In an example, one or more of the adjusted entry threshold, the configured entry threshold, alpha, and/or delta may be measured and/or determined in decibel (dB) scale.

The WTRU may monitor a PO associated with the WTRU and measure the one or more RSs for the MR measurement.

If the MR measurement satisfies the adjusted entry threshold, the WTRU may monitor the LP-WUS based on a LP-WUS monitoring occasion (MO) and stop monitoring the PO.

In an example, the WTRU may determine one or more adjusted quality of measurements based on one or more identified band parameters.

In an example,

$$Adjusted quality of measurement = Measured value + Alpha * Delta \qquad equation ( 7 )$$

$$Adjusted quality of measurement = Alpha * ( Measured value + Delta ) \qquad equation ( 8 )$$

$$Adjusted quality of measurement = Measured value + Alpha + Delta \qquad equation ( 9 )$$

$$Adjusted quality of measurement = Alpha * Measured Value \qquad equation ( 10 )$$

$$Adjusted quality of measurement = Alpha + Measured value \qquad equation ( 11 )$$

$$Adjusted quality of measurement = Measured Value + Delta \qquad equation ( 12 )$$

In an example, one or more of the adjusted quality of measurements may be measured and/or determined in the dB scale.

In an example, one or more methods and/or techniques for adjustment of one or more thresholds and/or qualities disclosed in the present disclosure may enable efficient entry and/or exit of the LP-WUS monitoring without redundant LR activation and/or deactivation by adjusting the one or more MR and/or LR measurements when the MR and the LR are associated with different bands and/or different bandwidths.

The WTRU may transmit and/or receive a physical channel and/or a reference signal (RS) according to at least one spatial domain filter. The term “beam” may be used to refer to a spatial domain filter.

The WTRU may transmit the physical channel and/or the reference signal using the same spatial domain filter as the spatial domain filter used for receiving the RS (such as but not limited to a channel state information (CSI-RS) and/or a SS block etc.). The WTRU transmission may be referred to as “target”, and the received RS and/or SS block may be referred to as “reference” or “source”. In such case, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as “target” and “reference” (or “source”), respectively. In such case, the WTRU may be said to transmit the first (i.e. target) physical channel and/or signal according to a spatial relation with a reference to the second (i.e. reference) physical channel and/or signal.

A spatial relation may be implicit, configured by radio resource control (RRC) and/or signaled by medium access control (MAC) control element (CE) and/or downlink control information (DCI) etc. In an example, the WTRU may implicitly transmit a physical uplink shared channel (PUSCH) and demodulation (DM) RS of the PUSCH according to the same spatial domain filter as a sounding reference signal (SRS) indicated by a SRS resource indicator (SRI) indicated in the DCI and/or configured by the RRC. In an example, a spatial relation may be configured by the RRC for the SRI and/or signaled by the MAC CE for a physical uplink control channel (PUCCH). Such spatial relation may also be referred to as a “beam indication”.

The WTRU may receive a first (target) downlink channel and/or signal according to the same spatial domain filter or spatial reception parameter as a second (reference) downlink channel and/or signal. In an example, such association may exist between a physical channel such as physical downlink control channel (PDCCH) or physical downlink shared channel (PDSCH) and respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. The WTRU may be indicated an association between a CSI-RS or SS block and a DM-RS by an index to a set of TCI states configured by the RRC and/or signaled by the MAC CE. Such indication may also be referred to as a “beam indication”.

For idle mode discontinuous reception (DRX) and paging in NR, the WTRU may use the DRX in RRC_IDLE and RRC_INACTIVE state in order to reduce power consumption. The WTRU may monitor one PO per DRX cycle. The PO is a set of PDCCH monitoring occasions and may include multiple time slots (e.g. subframe or OFDM symbol) where paging DCI may be transmitted. A paging frame (PF) is a radio frame and may include one or more POs or starting point of a PO.

In multi-beam operations, the WTRU may assume that the same paging message and the same short message are repeated in all transmitted beams and thus the selection of one or more beams for the reception of the paging message and the short message is up to WTRU implementation. The paging message is same for both RAN initiated paging and CN initiated paging.

The WTRU may initiate RRC connection resume procedure upon receiving the RAN initiated paging. If the WTRU receives the CN initiated paging in RRC_INACTIVE state, the WTRU moves to RRC_IDLE and informs the NAS.

When SearchSpaceId other than 0 is configured for pagingSearchSpace, the WTRU monitors the (i_s+1)th PO. A PO is a set of ‘S*X’ consecutive PDCCH monitoring occasions where ‘S’ is a number of one or more actual transmitted SSBs determined according to ssb-PositionsInBurst in SIB1 and X is a nrofPDCCH-MonitoringOccasionPerSSB-InPO if configured or is equal to 1 otherwise. The [x*S+K]th PDCCH monitoring occasion for paging in the PO corresponds to Kth transmitted SSB, where x=0, 1, . . . , X−1, K=1, 2, . . . , S. The one or more PDCCH monitoring occasions for paging which do not overlap with one or more uplink (UL) symbols (determined according to tdd-UL-DL-ConfigurationCommon) are sequentially numbered from zero starting from a first PDCCH monitoring occasion for paging in the PF. When firstPDCCH-MonitoringOccasionOfPO is present, a starting PDCCH monitoring occasion number of (i_s+1)th PO is the (i_s+1)th value of the firstPDCCH-MonitoringOccasionOfPO parameter; otherwise, it is equal to i_s*S*X. If X>1, when the WTRU detects a PDCCH transmission addressed to a paging-radio network temporary identifier (P-RNTI) within corresponding PO, the WTRU may not be required to monitor one or more subsequent PDCCH monitoring occasions for the PO. One or more of following parameters m used for the determination of the PF and i_s above:
T: DRX cycle of the WTRU (T is determined by the shortest of the UE specific DRX value(s), if configured by RRC and/or upper layers, and a default DRX value broadcast in system information. In RRC_IDLE state, if WTRU specific DRX is not configured by one or more upper layers, the default value may be applied).
N: number of total paging frames in T
Ns: number of paging occasions for a PF
PF_offset: offset used for PF determination
UE_ID: 5G-S-TMSI mod 1024

One or more parameters Ns, nAndPagingFrameOffset, nrofPDCCH-MonitoringOccasionPerSSB-InPO, and a length of default DRX cycle are signaled in SIB1. The values of N and PF_offset are derived from a parameter nAndPagingFrameOffset. A parameter first-PDCCH-MonitoringOccasionOfPO is signalled in SIB1 for paging in initial downlink (DL) bandwidth part (BWP). For paging in the DL BWP other than the initial DL BWP, the parameter first-PDCCH-MonitoringOccasionOfPO is signaled in the corresponding BWP configuration.

If the WTRU has no 5G-S-TMSI, for instance when the WTRU has not yet registered onto the network, the WTRU shall use as default identity UE_ID=0 in the aforementioned PF and i_s equations.

The WTRU may monitor for and/or listen to the paging message to know about one or more of incoming calls, system information change, earthquake and tsunami warning service (ETWS) notification for ETWS capable WTRUs, commercial mobile alert system (CMAS) notification and extended access barring parameters modification.

In RRC idle state, the WTRU monitors one or more short messages transmitted with the P-RNTI over the DCI and monitors a paging channel for the CN paging using 5G-S-TMSI. In RRC inactive state, the WTRU monitors the one or more short messages transmitted with the P-RNTI over the DCI and monitors the paging channel for the CN paging using 5G-S-TMSI and the RAN paging using full-RNTI. In RRC connected state, the WTRU may monitor the one or more short messages transmitted with the P-RNTI over the DCI.

In an example, a wake-up signal for idle mode paging may be utilized for the WTRUs supporting narrowband Internet of things (NB-IoT) or enhanced machine-type communication (eMTC). Similar to the connected mode, the WTRU monitors for the wake-up signal at a time specified by T_gap before the paging occasion. If the WTRU receives an indication that there may be paging addressed to that WTRU in a next paging time window then the WTRU monitors the PDCCH during each paging occasion of that paging time window. The paging time window is defined such that the WTRUs with a very long DRX in an order of minutes (eDRX) and which may suffer from clock drift compared to the network timing may reliably receive paging.

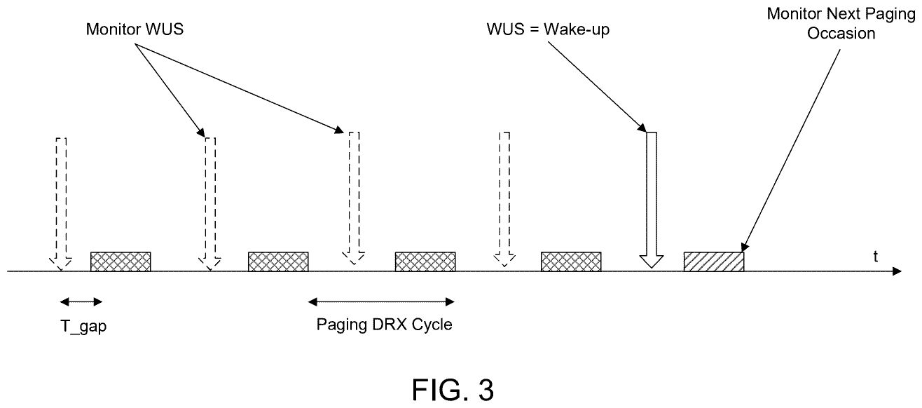

FIG. 3 illustrates an example idle mode wake-up signal according to one or more embodiments. In an example, a paging early indication (PEI) may be used in the NR. In that, the wake-up signal for the idle mode paging may be used. The PEI in DCI format 2-7 transmitted prior to the WTRU paging occasion may indicate whether the WTRU has to monitor the PDCCH and potentially the PDSCH to receive the paging message. The PEI may also include a paging indication which may indicate one or more WTRU subgroups in one or more paging occasions to be used for paging and/or tracking reference signal (TRS) availability indication for acquiring time and/or frequency synchronization for paging.

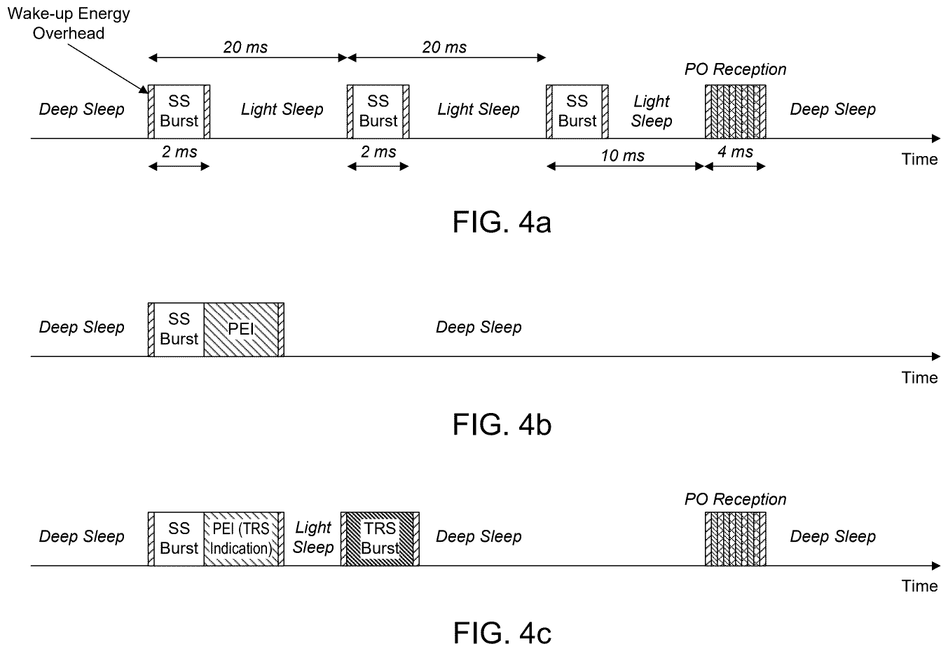

FIG. 4A illustrates an example WTRU power consumption in idle and/or inactive mode. In an example, conventionally, the WTRU had wake up to measure SS burst for time and/or frequency synchronization and monitor the POs, however, currently, the WTRU may maintain deep sleep if the WTRU does not receive the PEI. FIG. 4B illustrates an example WTRU power consumption using the PEI to indicate that the WTRU is not paged. In addition, if the WTRU receives the PEI, the WTRU may wake up, measure the TRS burst and receive the POs. FIG. 4C indicates an example WTRU power consumption including the PEI and the TRS availability. In an example, the WTRU may not need to periodically wake up to maintain time and/or frequency synchronization for the PO reception as the PEI may indicate the TRS burst for acquiring time and/or frequency synchronization.

Hereafter, a LP-WUS occasion (i.e. LO) may be interchangeably used with LP-WUS monitoring occasion (i.e. MO), but still consistent with the present disclosure.

In an example, the WTRU may receive the one or more configurations and/or configuration information, e.g., a configuration and/or information may be delivered via one or more of the SIB (e.g., SIB1), the RRC and/or the MAC CE etc. The one or more of configurations and/or the configuration information may be indicative of one or more of: the WTRU ID, one or more paging related configurations, one or more PEI related configurations, one or more configurations for the LP-WUS, and/or a subgroup ID etc.

In an example, the WTRU may receive the WTRU ID. For instance, 5G-S-TMSI mod 1024 may be used as the WTRU ID.

In the one or more paging related configurations, the WTRU may receive nAndPagingFrameOffset. In an example, the WTRU may receive information nAndPagingFrameOffset. Based on the received information, the WTRU may determine one or more of the following information, viz., a number of paging frames (N) and/or a paging frame offset etc.

In an example, the WTRU may receive and/or determine the information about the number of total paging frames (N) (e.g., via nAndPagingFrameOffset). In an example, one or more candidate values for the number of total paging frames may be different for different serving cell SSB periodicity.

In an example, the WTRU may receive and/or determine the information on the paging frame offset (e.g., via nAndPagingFrameOffset).

In the DRX cycle (T), the WTRU may receive information of the DRX cycle of the WTRU (T may be determined by the shortest of one or more WTRU specific DRX values, if configured by the RRC and/or upper layers, and a default DRX value broadcast in system information.

In an example, the WTRU may use a default value (e.g., in RRC_IDLE state, if the WTRU specific DRX is not configured by one or more upper layers, the default value may be applied).

In the number of paging occasions (e.g., for a PF) (Ns), the WTRU may receive the information of the number of paging occasions (e.g., per PF) for paging operation. For instance, the WTRU may receive one of 1, 2 or 4 paging occasions for paging operation.

In an example, the PEI related configuration may include a search space set (e.g., by pei-SearchSpace) etc. The WTRU may receive the information of one or more search space sets (e.g., to monitor the PDCCH for detection of DCI format 2_7 according to a Type2A-PDCCH CSS set).

For the number of paging occasions in the PEI (e.g., N_PO\hat{ }PEI), the WTRU may receive information of the number of paging occasions supported by the PEI. For instance, one of 1, 2, 4 or 8 may be indicated.

For the PEI payload size (e.g., by payloadSizeDCI-2-7), the WTRU may receive information of the PEI payload size. For instance, up to 41 bits and 43 bits for licensed and/or unlicensed spectrums, respectively, may be indicated.

For the PEI frame offset (e.g., by pei-FrameOffset), the WTRU may receive the frame offset for the PEI. For example, the WTRU may receive offset from the start of a reference frame for PEI-O (e.g., the start of a frame) to the start of a first paging frame of the one or more paging frames associated with a number of PDCCH monitoring occasions for DCI format 2_7.

For the PEI symbol offset (e.g., for PEI by firstPDCCH-MonitoringOccasionOfPEI-O), the WTRU may receive symbol offset for the PEI. For instance, the WTRU may receive offset (e.g., in number of symbols) from the start of the frame to the start of the first PDCCH monitoring occasion for DCI format 2_7.

For the number of subgroups (e.g., N_SG\hat{ }PO for PEI), the WTRU may receive the information of total number of subgroups (e.g., for PEI). For instance, the WTRU may receive one or both of subgroupsNumPerPO and subgroupsNumForUEID. Based on the received information, the WTRU may determine whether to use the WTRU ID based subgrouping and/or CN based subgrouping. For instance, if subgroupsNumForUEID is absent in subgroupConfig, the subgroup ID based on CN assigned subgrouping, if available for the WTRU, may be used. In an example, if both subgroupsNumPerPO and subgroupsNumForUEID are configured, and subgroupsNumForUEID has the same value as subgroupsNumPerPO, the subgroup ID based on the WTRU ID based subgrouping may be used in the cell. In an example, if both subgroupsNumPerPO and subgroupsNumForUEID are configured, and subgroupsNumForUEID<subgroupsNumPerPO.

The subgroup ID based on CN assigned subgrouping, if available for the WTRU, may be used in the cell. Otherwise, the subgroup ID based on the WTRU ID based subgrouping may be used in the cell. If the WTRU has no CN assigned subgroup ID or does not support CN assigned subgrouping, and there is no configuration for subgroupsNumForUEID, the WTRU may monitor the associated PO.

In an example, the one or more configurations for the LP-WUS may include the one or more LOs and the one or more MOs.

The WTRU may receive the one or more configurations associated with the one or more LOs. For instance, based on the one or more configurations of the one or more LOs, the WTRU may receive configurations of N*K MOs (e.g., by receiving N*K sets of resources) for each LO where N may be a number of beams corresponding to the LP-WUS and K may be a number of LP-WUS MOs for each beam. The configuration of the one or more LOs (e.g., each LO) and/or the one or more MOs (e.g., each MO) may be based on one or more of the following: one or more of a sequence ID, a scrambling ID and/or cell ID etc.

The WTRU may receive the configuration indicative of one or more of a sequence ID, a scrambling ID and/or a cell ID etc. For instance, the WTRU may receive the LP-WUS in a LP-WUS resource by using a sequence which is generated by using the ID and/or data which is scrambled by using the ID (e.g., in time and/or frequency domain).

The WTRU may receive a configuration of a signal structure. For instance, the WTRU may receive one or more of: a support of preamble, a preamble length (if configured), a message type (e.g., sequence and/or encoded data), and/or a number of repetitions etc.

The WTRU may receive the configuration of a waveform. For instance, the WTRU may receive one of OOK-1, OOK-4, OFDMA or etc. as a waveform of the LP-WUS. For OOK-4, M may be additionally configured.

The WTRU may receive the configuration of a monitoring type. For instance, the WTRU may receive one or more of continuous monitoring and/or duty-cycled monitoring.

The WTRU may receive the configuration of one or more absolute frequency resources. For instance, the WTRU may receive the configuration based on one or more of RBs, sub bands, and/or BWPs etc. to indicate one or more frequency resources for receiving the LP-WUS.

The WTRU may receive the configuration of one or more relative time resources. For instance, the WTRU may receive the frequency offset (e.g., in the RBs, the sub bands, and/or the RBGs etc.) from one or more reference resources.

The WTRU may receive the configuration of one or more absolute time resources. For instance, the WTRU may receive the configuration based on one or more of the periodicity and/or the offsets etc. The indication of the configuration may be based on the OFDM symbols and/or slots etc.

The WTRU may receive an implicit configuration of the one or more time resources. For instance, the WTRU may receive the time offset (e.g., in symbols, subframes, and/or frames etc.) from the one or more reference resources.

In an example, the one or more reference resources may be one or more of a start of a frame, an associated paging frame, an associated paging occasion, one or more associated LOs (e.g., for the one or more MOs), an associated PEI search space, the SSB (e.g., the PSS and/or the SSS in the NR-SS), and/or the LP-SS etc.

The WTRU may receive the indication of a number of subgroups (e.g., for the LP-WUS operation and/or for each LP-WUS MO). The WTRU may receive the information about the number of subgroups for the LP-WUS. In an example, the number of subgroups may be total number of subgroups for the LP-WUS operation. In an example, the number of subgroups may be the number of subgroups supported by each LO and/or MO etc.

The WTRU may determine the number of subgroups based on the received information. For instance, the WTRU may use the number of subgroups for the PEI as the number of subgroups for the LP-WUS. In another example, the WTRU may determine the number of subgroups for the LP-WUS as a scaling factor * the number of subgroups for the PEI. The scaling factor may be indicated via one or more of the SIB, the RRC and/or the MAC CE etc.

The WTRU may determine a size of the LP-WUS information. The WTRU may receive information of a LP-WUS payload size. For instance, up to 8, 16 or 24 bits may be indicated.

The WTRU may receive the size of the LP-WUS information for each information type. For instance, the WTRU may receive a first size of the LP-WUS information for a first information type (e.g., for one or more of the TRS availability indication, a SI change, a ETWS and/or CMAS information etc.). The WTRU may receive a second size of the LP-WUS information for a second information type (e.g., a subgroup indication).

The WTRU may receive a frame offset for the LP-WUS. For instance, the WTRU may receive the offset from a start of a reference frame for the LP-WUS (e.g., the start of the frame) to a start of a first paging frame of one or more paging frames associated with the LP-WUS monitoring for the WTRU.

The WTRU may receive a symbol offset for the LP-WUS. For instance, the WTRU may receive offset (e.g., in number of symbols) from the start of the frame to the start of the first LP-WUS monitoring occasion (e.g., for monitoring the LP-WUS).

The WTRU may receive a subgroup ID (e.g., for the PEI and/or the LP-WUS etc.). For instance, the WTRU may receive one or more subgroup IDs from the AMF via the NAS signaling (e.g., in the CN based subgrouping). In another example, the WTRU may determine the subgroup ID based on the WTRU ID and the total number of subgroups for the WTRU ID based subgrouping.

The WTRU may receive the subgroup ID for both the PEI and the LP-WUS). In an example, the WTRU may receive a first subgroup ID for the PEI and a second subgroup ID for the LP-WUS. In an example, the WTRU may receive the subgroup ID for the PEI and determine the subgroup ID for the LP-WUS based on the received information. In another example, the WTRU may determine one or more subgroup IDs for the PEI and the LP-WUS, respectively, based on the received information (e.g., the WTRU ID).

The WTRU may determine the one or more POs associated with the WTRU. For instance, the WTRU may determine the one or more associated POs based on the WTRU ID. In an example, the WTRU may determine a PO ID based on i_s: floor (UE_ID/N) mod N_s. In another example, i_PO=((UE_IDmodN)·N_S+i_s) mod N_PO\hat{ }PEI may be used.

The WTRU may determine the one or more LOs associated with the WTRU. The WTRU may determine the one or more LOs based on one or more of: the WTRU ID, an associated PO, and/or an associated PF etc.

The WTRU may determine the one or more LOs based on the WTRU ID. For instance, an associated LO ID may be floor (UE_ID/N) mod N_LO wherein N_LO may be total number of LOs (e.g., for a PF).

Based on the one or more determined POs, the WTRU may determine the one or more LOs. For instance, the LO may be associated with each PO (e.g., based on time and/or frequency offset etc.). The WTRU may determine the LO which is associated with the determined PO (e.g., based on the WTRU ID).

The WTRU may determine one or more associated PFs based on the WTRU ID.

Based on the determined PFs, the WTRU may determine the one or more LOs. For instance, the LO may be associated with each PF (e.g., based on time and/or frequency offset etc.). The WTRU may determine the LO which is associated with the determined PF (e.g., based on the WTRU ID).

The WTRU may determine the one or more MOs associated the WTRU. The WTRU may determine the one or more MOs based on one or more of: the WTRU ID, the associated PO, and/or the associated LO etc.

The WTRU may determine the one or more LOs based on the WTRU ID.

Based on the determined PO, the WTRU may determine the one or more MOs. For instance, the one or more MOs may be associated with each PO (e.g., based on time and/or frequency offset etc.). The WTRU may determine the one or more MOs which are associated with the determined PO (e.g., based on the WTRU ID).

Based on the determined LO, the WTRU may determine the one or more MOs. For instance, the LO may be associated with each PO (e.g., based on time and/or frequency offset). The WTRU may determine the one or more MOs which are associated with the determined PO (e.g., based on the WTRU ID).

The WTRU may determine the one or more associated PFs based on the WTRU ID. Based on the determined PFs, the WTRU may determine the one or more LOs. For instance, the LO may be associated with each PF (e.g., based on time and/or frequency offset etc.). The WTRU may determine the LO which is associated with the determined PF (e.g., based on the WTRU ID).

In a solution, the WTRU may determine the LP-WUS information based on the received information. For instance, the WTRU may determine whether to split the subgroup information into two or more LOs and/or MOs. For instance, the WTRU may determine whether to split the subgroup information based on the size of the LP-WUS information. For instance, the WTRU may determine the number of subgroups based on the size of LP-WUS information (e.g., for subgroups) and the number of subgroups for the LP-WUS. For instance, if the size of the LP-WUS information (e.g., for all the LP-WUS and all subgroup information)>=required size of information for all the subgroups (e.g., the number of all the subgroups (e.g., for the LP-WUS) if a bitmap is used), the WTRU may receive the information of all the subgroups within one associated LO and/or MO of the LP-WUS with the WTRU. If the size of the LP-WUS information (e.g., for all the LP-WUS or all the subgroup information)<required size of information for all the subgroups (e.g., the number of subgroups (e.g., for the LP-WUS) if the bitmap is used), the WTRU may receive information of all the subgroups within two or more associated LOs and/or MOs.

Based on the determination, the WTRU may split the subgroup information into two or more LOs and/or MOs. The split of the subgroup information may be based on one or more of: the number of subgroups for each LO or MO, the number of associated LOs and/or MOs, and/or based on a number of subgroups for the PEI.

The WTRU may receive the number of subgroups for each LO and/or MO (e.g., via one or more of the SIB, the RRC and/or the MAC CE etc.). Based on the number of subgroups, the WTRU may determine the one or more LOs and/or MOs indicating the set of subgroups. For instance, if 8 subgroup is supported and 4 subgroups for each MO is indicated, then first 4 subgroup information may be indicated in a first MO and second 4 subgroup information may be indicated in a second MO.

The WTRU may determine the number of subgroups for each LO and/or MO based on the number of one or more associated LOs (e.g., per PO or paging frame e.g., within a same beam) or the one or more POs (e.g., per LO, PO or paging frame e.g., within the same beam). The WTRU may receive S subgroups in each MO wherein S may be total number of subgroups/K (number of MOs within a LO with a same beam).

The WTRU may receive a total number of subgroups for the PEI (e.g., via the one or more of the SIB, the RRC and/or the MAC CE etc.). For instance, the WTRU may receive the indication of the total number of subgroups for the PEI in each LO and/or MO. For instance, if 8 subgroups are configured for the PEI and 16 subgroups are configured for the LP-WUS, then the first MO may indicate a first 8 subgroup and a second MO may indicate a second 8 subgroup.

The WTRU may determine a subgroup ID of the WTRU for the LP-WUS. The determination may be based on one or more of: an identical subgroup ID with the PEI, an indicated subgroup ID for the LP-WUS, and/or a determined subgroup ID for the LP-WUS etc.

The WTRU may use the same subgroup ID used for the PEI. The same subgroup ID may be used if the number of subgroups for the LP-WUS is same with the number of subgroups for the PEI (e.g., if number of subgroup in the LP-WUS=number of subgroup in the PEI).

The WTRU may receive the indication of the subgroup ID for the LP-WUS (e.g., via one or more of the NAS signaling from the AMF, the SIB, the RRC and/or the MAC CE etc.).

The WTRU may determine the subgroup ID for the LP-WUS. For instance, the WTRU may determine the WTRU subgroup ID for the LP-WUS based on the WTRU subgroup ID for the PEI. For instance, e.g., if the number of subgroups in the LP-WUS>the number of subgroups in the PEI, the WTRU subgroup ID in the LP-WUS may be the WTRU subgroup ID in the PEI*Number of subgroup in the LP-WUS/number of subgroup in the PEI (or indicated scaling factor)+mod (UE_ID, Number of subgroup in LP-WUS/number of subgroup in PEI (or indicated scaling factor)). In another example, e.g., if the number of subgroup in the LP-WUS<number of subgroup in the PEI, the WTRU subgroup ID in the LP-WUS may be floor (the WTRU subgroup ID/Number of subgroup in LP-WUS*number of subgroup in PEI).

The WTRU may determine the one or LOs and MOs to monitor the LP-WUS. The WTRU may monitor all the LOs and/or MOs associated with the WTRU (e.g., based on the WTRU ID and/or the associated PO etc.). The WTRU may monitor the one or more LOs and/or MOs associated with the WTRU subgroup ID (e.g., among the LOs and/or MOs associated with the WTRU ID and/or the associated PO etc.). The WTRU may only monitor the one or more LOs and/or MOs which indicate the determined WTRU subgroup ID. The WTRU monitors the one or more LOs and/or MOs delivering common information. The WTRU may monitor the one or more LOs and/or MOs delivering the TRS availability information, a SI change, the ETWS and/or CMAS information and etc.

The WTRU may apply indicated information via the LP-WUS if the WTRU detects the LP-WUS in the one or more determined LOs and/or MOs. For instance, if the WTRU detects SI change, the WTRU may apply the indicated set of the system information. In an example, if the WTRU detects the SI change, the WTRU may activate the MR and/or receive updated system information. In an example, if the WTRU receives the ETWS and/or CMAS information, the WTRU may apply the indicated information. If the WTRU detects the TRS availability indication, the WTRU may use the indicated information to identify a TRS location for time and/or frequency synchronization when the WTRU monitors the PDCCH (e.g., after activation of the MR). In an example, if the WTRU detects the LP-WUS indicating the WTRU subgroup ID (e.g., for the LP-WUS) in the received LP-WUS, the WTRU may monitor the PEI and/or the associated PO with the WTRU. If the WTRU receives the paging message, the WTRU may respond e.g., transmit the PRACH.

In various embodiments, the WTRU may receive (e.g., via one or more of the SIB, the RRC and/or the MAC CE etc.) the one or more configurations related to the LP-WUS monitoring and/or paging, the WTRU ID, the number of total paging frames, the number of paging occasions, the number of subgroups for the LP-WUS, the one or more offsets (e.g., the paging frame offset and/or the OFDM symbol offset etc.), the configuration of the LP-WUS occasion (i.e. the LO) and the LP-WUS monitoring occasion (i.e. MO) (e.g., based on the offset between paging frame and LO and/or MO), the one or more RSs for the LR measurement (e.g., a low power synchronization signal (LP-SS)).

The WTRU may be configured with the one or more sets of the LP-SS resources and/or one or more LP-WUS preambles for measuring quality of a LR channel. The WTRU may receive the one or more RSs for the MR (e.g., the one or more SSBs).

The WTRU may be configured with the one or more sets of SSBs and/or the one or more RS resources for measuring quality of a MR channel.

In an example, the WTRU may receive and/or may be configured with one or more candidate values for the alpha adjustment parameter (i.e. the alpha) wherein each candidate value is associated with a bandwidth ratio (e.g., bandwidth of NR/bandwidth of LR)

In an example, the WTRU may receive and/or may be configured with one or more candidate values for the delta adjustment parameter wherein each candidate value is associated with a band difference.

The WTRU may be configured and/or indicated and/or the WTRU may identify a set of band parameters related to the MR and the LR, respectively, for example, one or more cell IDs, one or more band related parameters etc. For instance, a list of carrier frequencies may be configured and/or identified. The WTRU may identify one or more bandwidths. For instance, a bandwidth for each band and/or bandwidth part and/or carrier frequency may be configured and/or identified. The WTRU may identify and/or be configured with one or more thresholds. For instance, a threshold for one or more entry conditions (and/or activation) for the MR associated with the LP-WUS monitoring may be configured (e.g., in one or more of the RSRP, the RSRQ, and/or the RSSI etc.). For instance, a threshold for one or more exit conditions (and/or deactivation) for the LR associated with the LP-WUS monitoring may be configured (e.g., in the LP-RSRP, the LP-RSRQ, the LP-RSSI, the RSRP, the RSRQ, and/or the RSSI etc.).

The WTRU may determine the one or more parameters (e.g., for adjusting the one or more thresholds and/or measured qualities etc.). For instance, the WTRU may determine the one or more adjustment parameters (e.g., the alpha) based on the bandwidth ratio between the MR and the LR bands and/or band combinations.

The WTRU may be configured with the one or more candidate values wherein each candidate value may be associated with each band and/or band combination ratio between the MR and the LR.

One or more example candidate values based on the band difference between the MR and the LR are shown in Table 2.

TABLE 2

| | |
|---|---|
| Band difference between MR and LR | Candidate value |

| | | |
|---|---|---|
| <100 | MHz | Value 0 |
| <200 | MHz | Value 1 |
| <300 | MHz | Value 2 |
| <500 | MHz | Value 3 |
| <700 | MHz | Value 4 |
| <1 | GHz | Value 5 |

The WTRU may determine the one or more predefined candidate values wherein each candidate value may be associated with each band and/or band combination ratio difference between the MR and the LR. The WTRU may determine the one or more adjustment parameters (e.g., the delta) based on difference and/or distance between the MR and the LR bands and/or band combinations and/or carrier frequencies.

The WTRU may be configured with the one or more candidate values wherein each candidate value may be associated with each band and/or band combination ratio between the MR and the LR.

The WTRU may determine the one or more predefined candidate values wherein each candidate value may be associated with each band and/or band combination ratio.

In an example, different band and/or band combination ratios may be used for different adjustment cases. For instance, if the WTRU adjusts the MR value for the LR band, then the WTRU may use a first bandwidth ratio (e.g., the first bandwidth ratio=MR bandwidth/LR bandwidth). If the WTRU adjust the LR value for the MR band, then the WTRU may use a second bandwidth ratio (e.g., the second bandwidth ratio=LR bandwidth/MR bandwidth).

In an example, different ranges of bandwidth ratio and/or candidate values may be used for different adjustment cases. For instance, if the WTRU adjusts the MR value for the LR band, then the WTRU may use a first set of ranges and/or candidate values (e.g., shown in Table 3). If the WTRU adjusts the LR value for MR band, then the WTRU may use a second set of ranges and candidate values (e.g., shown in Table 4).

One or more example candidate values based on the bandwidth ratio between the MR and the LR are shown in Table 3.

TABLE 3

| Band ratio between MR and LR | |
|---|---|
| (e.g., LR band/MR band) | Candidate value |
| 1 | Value 0 |
| <1 | Value 1 |
| <0.75 | Value 2 |
| <0.5 | Value 3 |
| <0.25 | Value 4 |

One or more example candidate values based on the bandwidth ratio between the MR and the LR are shown in Table 4

TABLE 4

| Band ratio between MR and LR | |
|---|---|
| (e.g., MR band/LR band) | Candidate value |
| 1 | Value 0 |
| >1 | Value 1 |
| >2 | Value 2 |
| >3 | Value 3 |
| >5 | Value 4 |

In an example, the configuration and/or determination of the one or more candidate values may be done based on one or more of: per WTRU, per band, per bandwidth, and/or per band combination etc.

The WTRU may be configured with and/or the WTRU may determine the set of candidate values regardless of different bands, bandwidths and/or band combinations.

The WTRU may be configured with and/or the WTRU may determine different set of candidate values for different bands of the MR and/or the LR.

The WTRU may be configured with and/or the WTRU may determine different set for different bandwidth of the MR and/or the LR.

The WTRU may be configured with and/or the WTRU may determine different set of candidate values for different band combinations of the MR and/or the LR.

The WTRU may determine one or more measurement qualities and/or thresholds based on the determined one or more adjustment parameters. For instance, if the WTRU determines the one or more thresholds based on the determined one or more adjustment parameters, one or more of the following methods may be used:

$$Adjusted threshold = configured entry threshold + alpha ( parameter based on bandwidth ratio ) * delta ( parameter based on band difference ) \qquad equation ( 13 )$$

$$Adjusted threshold = configured entry threshold + delta ( parameter based on band difference ) / \\ alpha ( parameter based on bandwidth ratio ) \qquad equation ( 14 )$$

$$Adjusted threshold = alpha * ( configured entry threshold + delta ) \qquad equation ( 15 )$$

$$Adjusted threshold = ( configured entry threshold + delta ) / alpha \qquad equation ( 16 )$$

$$Adjusted threshold = alpha * ( configured entry threshold - delta ) \qquad equation ( 17 )$$

$$Adjusted threshold = ( configured entry threshold - delta ) / alpha \qquad equation ( 18 )$$

$$Adjusted threshold = configured entry threshold + alpha + delta ( e . g . , in dB scale ) \qquad equation ( 19 )$$

$$Adjusted threshold = configured entry threshold + alpha - delta ( e . g . , in dB scale ) \qquad equation ( 20 )$$

$$Adjusted threshold = configured entry threshold - alpha + delta ( e . g . , in dB scale ) \qquad equation ( 21 )$$

$$Adjusted threshold = configured entry threshold - alpha - delta ( e . g . , in dB scale ) \qquad equation ( 22 )$$

$$Adjusted threshold = alpha * configured entry threshold \qquad equation ( 23 )$$

$$Adjusted threshold = alpha + configured entry threshold \qquad equation ( 24 )$$

$$Adjusted threshold = Configured entry threshold + Delta \qquad equation ( 25 )$$

In an example, if the WTRU determines the one or more measurements based on the determined one or more adjustment parameters, one or more of the following methods may be used:

$$Ad justed quality = measured quality + alpha ( parameter based on bandwidth ratio ) * delta ( parameter based on band difference ) \qquad equation ( 26 )$$

$$Adjusted quality = measured quality + delta ( parameter based on band difference ) / \\ alpha ( parameter based on bandwidth ratio ) \qquad equation ( 27 )$$

$$Adjusted quality = alpha * ( measured quality + delta ) \qquad equation ( 28 )$$

$$Adjusted quality = ( measured quality + delta ) / alpha \qquad equation ( 29 )$$

$$Adjusted quality = alpha * ( measured quality - delta ) \qquad equation ( 30 )$$

$$Adjusted quality = ( measured quality - delta ) / alpha \qquad equation ( 31 )$$

$$A djusted quality = measured quality + alpha + delta ( e . g . , in dB scale ) \qquad equation ( 32 )$$

$$Adjusted quality = measured quality + alpha - delta ( e . g . , in dB scale ) \qquad equation ( 33 )$$

$$Adjusted quality = measured quality - alpha + delta ( e . g . , in dB scale ) \qquad equation ( 34 )$$

$$Adjusted quality = measured quality - alpha - delta ( e . g . , in dB scale ) \qquad equation ( 35 )$$

$$Adjusted quality = alpha * measured quality \qquad equation ( 36 )$$

$$Adjusted quality = alpha + measured quality \qquad equation ( 37 )$$

$$Adjusted quality = measured quality + delta \qquad equation ( 38 )$$

In an example, different adjustment equations may be used for different adjustment cases. For instance, if the WTRU adjusts the MR band values for the LR band, then the WTRU may use a first equation (e.g., adjusted threshold=alpha*(configured entry threshold+delta)). If the WTRU adjust LR value for the MR band, then the WTRU may use a second equation (e.g., adjusted threshold=(configured entry threshold−delta)/alpha).

Based on the adjusted thresholds and/or the adjusted qualities, the WTRU may determine whether to activate the LP-WUS monitoring (e.g., in the one or more configured MOs and/or LOs associated with the WTRU) and/or stop monitoring the one or more POs.

The measured quality based on the MR may exceed the adjusted threshold of the LR (e.g. the LR threshold and/or the adjusted LR threshold) for the MR band. The WTRU may use the measured quality by measuring the one or more RSs (e.g., the one or more of the SSB, the CSI-RS, the DM-RS, and/or the PT-RS etc.) for the MR measurement.

If the measured quality exceeds the adjusted configured entry threshold of the MR for the LR band, then the WTRU may activate the LP-WUS monitoring and/or stop monitoring the one or more POs.

The adjusted quality of the MR for the LR band may exceed the configured threshold of the MR. The WTRU may adjust the measured quality based on the determined parameters. If the adjusted measured quality exceeds the configured entry threshold for the MR band, then the WTRU may activate the LP-WUS monitoring and/or stop monitoring the one or more POs.

In an example, if the one or more entry conditions are satisfied, the WTRU may start the LP-WUS monitoring in the one or more configured MOs and/or the one or more LOs associated with the WTRU.

The WTRU may determine whether to deactivate the LP-WUS monitoring and/or start monitoring the one more POs based on one or more of: the measured quality, the adjusted quality, the configured exit threshold, the adjusted exit threshold and/or the LR measurements etc.

If the measured quality based on the LR exceeds the adjusted threshold of the MR for the LR band, for example, the WTRU may use measured quality by measuring the one or more RSs (e.g., the one or more of LP-SS, the one or more preambles of the LP-WUS and etc.) for the LR measurement.

If the measured quality exceeds the adjusted configured exit threshold of the MR for the LR band, then the WTRU may stop the LP-WUS monitoring and/or start monitoring the one or more POs.

If the adjusted quality of the LR for the MR band exceeds the configured threshold of the LR, for example, the WTRU may adjust the measured quality based on the determined parameters. If the adjusted measured quality exceeds the configured exit threshold for the MR band, then the WTRU may stop the LP-WUS monitoring and/or start monitoring the one or more POs.

In one or more embodiments, a method for adjustment of one or more LR measurements for determining a cell for camping based on the one or more bands for the MR and the LR is provided.

In that, the WTRU may receive the one or more configurations and/or the configuration information including various parameters.

The WTRU may receive and/or be configured with two or more sets of RSs (e.g., the LP-SS) for two or more cells (e.g., serving cell and/or neighboring cells etc.) wherein each set of RSs may be associated with each cell.

The WTRU may receive and/or be configured with the MR threshold for the entry condition of the LP-WUS monitoring.

The WTRU may receive and/or be configured with the LR threshold for the exit condition of the LP-WUS monitoring.

The WTRU may receive and/or be configured with one or more first adjustment factors, such as the delta, wherein each adjustment factor may be associated with a band difference between the MR band and the LR band.

The WTRU may receive and/or be configured with one or more second adjustment factors, the alpha, wherein each adjustment factor may be associated with a bandwidth ratio between the MR band and the LR band.

The WTRU may receive and/or be configured with the one or more band difference thresholds.

The WTRU may receive and/or be configured with the one or more bandwidth ratio thresholds.

The WTRU may activate the LP-WUS monitoring if a quality of a set of RSs (e.g., a serving cell) among two or more sets exceeds the MR threshold for the entry condition.

The WTRU may perform the one or more measurements of the serving cell and one or more neighboring cells based on the two or more sets of RSs.

The WTRU may select a first adjustment factor from the one or more first adjustment factors based on the band difference between the MR and the LR, for example, if the MR band=the LR band, the WTRU may determine a first value (e.g., 0). If the MR band−the LR band>a first band difference threshold, the WTRU may determine a second value (e.g., small adjustment). If the MR band−the LR band>a second band difference threshold, the WTRU may determine a third value (e.g., large adjustment).

The WTRU may select a second adjustment factor among the one or more second adjustment factors based on bandwidth ratio between MR and LR in each cell, for example, if the MR bandwidth=the LR bandwidth band, the WTRU may determine a first value (e.g., 0 (dB) if addition is used or 1 if multiplication is used). If MR band/LR band>a first bandwidth ratio threshold, the WTRU may determine a second value (e.g., small adjustment). If the MR band−the LR band>a second bandwidth ratio threshold, the WTRU may determine a third value (e.g., large adjustment).

The WTRU may determine a quality of the two or more cells based on the one or more measurements, the first adjustment factor and/or the second adjustment factor, for example:

$$Quality = measured value + alpha * delta \qquad equation ( 39 )$$

$$Quality = alpha * ( measured value + delta ) \qquad equation ( 40 )$$

$$Quality = measured value + alpha + delta ( e . g . , in dB scale ) \qquad equation ( 41 )$$

The WTRU may determine the cell (e.g., a best cell) among the two or more cells for camping based on the adjusted quality.

For cell selection and/or reselection, the WTRU may perform the cell selection with or without stored cell information. The cell information may include one or more frequencies and/or cell parameters. In an example, the cell may be defined as a combination of one or more uplink component carriers (CC) and one or more downlink component carriers. The WTRU may have (previously) stored information about the one or more cells based on one or more previously received measurement control information elements or from previously detected cells. If the WTRU has stored cell information, the WTRU may leverage it for the cell selection.

In case there is no stored information and/or if the cell search based on the stored information has no results, the WTRU may perform initial cell selection, where the WTRU may have no prior knowledge of one or more cell parameters. For instance, the WTRU may not have knowledge of which RF channels are NR frequencies. As such, the WTRU may scan and/or monitor one or more RF channels for example from a set of RF channels (e.g., based on the synchronization raster frequencies) in the NR bands to find a suitable cell. In an example, a synchronization raster may indicate one or more frequency positions of the synchronization block (e.g., the SS/PBCH block) that may be used by the WTRU for system acquisition when explicit signaling of the synchronization block position is not present. As such, the WTRU may search to find the SS/PBCH blocks (SSB) corresponding to one and more cells on each frequency channel and/or raster, where the WTRU may select the strongest cell based on the measuring the RSSI, the RSRP, the RSRQ, the SINR, and so forth for the detected SSB.

In an example, one or more criteria for a suitable cell may be used. Upon finding the suitable cell, the WTRU may select the suitable cell as the serving cell. In an example, the WTRU may use the one or more criteria to select a candidate cell as the suitable cell. The WTRU may determine the criteria based on one or more evaluated parameters. The WTRU may determine the one or more evaluated parameters based on one or more of measured parameters, compensation values, and/or scaling rules etc. For instance, the WTRU may determine one or more compensation values and/or one or more scaling rules based on the one or more configured and/or indicated offsets, parameters, and/or configured values etc. In an example, the WTRU may be configured with and/or the WTRU may determine one or more parameters such as but not limited to a measured cell received power value, a measured cell quality value, a minimum required measured RX power level and/or quality level in a cell, one or more compensation values, an evaluated cell selection and/or reselection reception (Rx) power level value, an evaluated cell selection and/or reselection quality value, etc.

The WTRU may measure the reference signal received power (RSRP), signal-to-noise and interference ratio (SINR), received signal strength indicator (RSSI), and so forth for the one or more SSBs, the one or more reference signals, and/or one or more channels etc.

The WTRU may measure a reference signal received quality (RSRQ) for one or more SSBs, reference signals, and/or channels etc.

The WTRU may receive, determine, and/or be configured with the one or more parameters and/or offset values to determine the minimum required Rx level (e.g., in dBm) and/or minimum required quality level (e.g., dB) in the corresponding cell.

The WTRU may receive, determine, and/or be configured with the one or more parameters, offset, and/or scaling values etc. that may be used upon receiving the indication, and/or based on one or more modes of operation, and/or thresholds etc.

The WTRU may compute, evaluate, and/or calculate the received power level value (e.g., in dB) based on one or more measured parameters and/or compensation and/or scaling values. In an example, the WTRU may calculate the evaluated cell selection and/or reselection Rx power level value (e.g., Srxlev) based on a measured cell received power level value (e.g., Qᵣₓₗₑᵥₘₑₐₛ), the minimum required measured Rx power level (e.g., Qᵣₓₗₑᵥₘᵢₙ and/or Q_{rxlevminoffset}), the one or more compensation parameters (e.g., P_{compensation}), one or more temporary offset values (e.g., Qoffsetₜₑₘₚ), and so forth (e.g., Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ). As such, the WTRU may select the corresponding cell as one of the candidate suitable cells if the evaluated cell selection and/or reselection Rx power level value is higher than a configured and/or preconfigured threshold (e.g., Srxlev>0 for cell selection, or Srxlev>SintraSearchP or Srxlev>SnonIntraSearchP for intra-frequency and inter-frequency, respectively, cell reselection, and so forth).

The WTRU may compute, evaluate, and/or calculate the received quality value (e.g., in dB) based on one or more measured parameters and/or compensation and/or scaling values. In an example, the WTRU may calculate the one or more evaluated cell selection and/or reselection quality value (e.g., Squal) based on the measured cell quality value (e.g., Q_{qualmeas}), the minimum required quality level (e.g., Q_{qualmin} and/or Q_{qualminoffset}), one or more temporary offset values (e.g., Qoffsetₜₑₘₚ), and so forth (e.g., Squal=Q_{qualmeas}−(Q_{qualmin}+Q_{qualminoffset})−Qoffsetₜₑₘₚ). As such, the WTRU may select the corresponding cell as one of the candidate suitable cells if the evaluated cell selection and/or reselection quality value is higher than a configured and/or preconfigured threshold (e.g., Squal>0, or Squal>SintraSearchQ, or Squal>SnonIntraSearchQ for intra-frequency and inter-frequency, respectively, cell reselection etc.).

The WTRU may receive and/or be configured with one or more of the compensation and/or scaling parameters, values, settings, and/or rules as the criteria for cell selection and/or reselection via one or more implicit and/or explicit indications. The one or more explicit indications may be via master information block (MIB) in corresponding SSB, system information blocks (SIB), semi-static configuration (e.g., via the RRC), dynamic indication (e.g., via the MAC-CE and/or the DCI) etc. The WTRU may determine to use one or more compensation and/or scaling rules based on implicit indication, that is based on comparing one or more parameters with one or more corresponding thresholds, for instance.

In an example, upon measuring and calculating the evaluated received power and/or evaluated quality value, the WTRU may perform cell ranking for all the cells (e.g., the serving and/or neighbor cells etc.) that the WTRU determined as the candidate suitable cells based on the cell selection criteria. For instance, the WTRU may determine the cell ranking based on the calculating the R values using average RSRP results. One or more of the following may apply. The following parameters are non-limiting examples of the one or more parameters that may be included in a cell ranking calculation and measurement. In an example, one or more of these parameters may be included. In an example, one or more other and/or different parameters may be included.

$${R}_{s} = {Q}_{meas , s} + {Q}_{hyst} - {Qoffset}_{temp} \qquad equation ( 42 )$$

$${R}_{n} = {Q}_{meas , n} - Qoffset - {Qoffset}_{temp} \qquad equation ( 43 )$$

Where, Rs and Rn correspond to the serving and neighbor cells, respectively. In an example, in the above equation, Q_{hyst} may represent the mobility aspects of the WTRU. Q_{offset} may be configured with different values for intra-frequency and/or inter-frequency cell selections and/or reselections, and Qₘₑₐₛ may be the measured RSRP quantity used in cell selection and/or reselection.

The WTRU may reselect a new candidate cell, if the new cell has higher R value than the serving cell during a configured and/or preconfigured time interval.

The WTRU may receive the one or more configurations and/or the configuration information from the gNB and/or network (e.g., via the SIB, the RRC signaling, the MAC-CE indication, and/or the DCI indication etc.).

The WTRU may receive and/or determine two or more sets of RSs (e.g., the LP-SS) for two or more cells. For instance, the WTRU may receive two sets of RSs (e.g., 1^{st} set of the LP-SSs and 2^{nd} set of the LP-SSs), each associated with the cell (e.g., the serving cell and/or the neighboring cell etc.).

The WTRU may receive and/or determine a threshold (the MR threshold for an entry condition) on one or more MR measurements (e.g., SSB signal strength) to be used as the entry condition of the LP-WUS monitoring.

The WTRU may receive and/or determine a threshold on one or more LR measurements (e.g., the LP-SS signal strength), e.g. the LR threshold, to be used as the exit condition of the LP-WUS monitoring.

The WTRU may receive and/or determine the one or more first adjustment factors (e.g. the delta), wherein each adjustment factor may be associated with a difference between the one or more frequency bands of the MR and the LR.

The WTRU may receive and/or determine the one or more second adjustment factors (i.e. the alpha), wherein each adjustment factor may be associated with the bandwidth ratio between the MR frequency band and the LR frequency band.

The WTRU may receive and/or determine the one or more thresholds on a frequency band difference (e.g., a first band difference threshold, a second band difference threshold etc.).

The WTRU may receive and/or determine the one or more thresholds on the bandwidth ratio (e.g. the first bandwidth ratio threshold, the second bandwidth ratio threshold etc.).

For activating the LP-WUS monitoring and/or measuring, the WTRU may receive the configuration and/or the indication to start the LP-WUS monitoring. For instance, the WTRU in RRC IDLE or INACTIVE may receive the indication (e.g., via SI, paging PDCCH, PDSCH, and/or MAC-CE etc.) to start monitoring the LP-WUS. In another example, the WTRU in RRC CONNECTED state may receive a RRC release message. The RRC release message may include the indication to start the LP-WUS monitoring.

The WTRU may perform the one or more RS measurements (e.g., the RSRP) associated with two or more RS sets (e.g., 1^{st} set of SSBs associated with 1^{st} cell and 2^{nd} set of SSBs associated with 2^{nd} cell). The WTRU may activate the LP-WUS monitoring based on the quality of the set of RSs (e.g., the set of RSs associated with serving cell) among the two or more RS sets. For instance, if the quality of the RS set associated with the serving cell exceeds the MR threshold for the entry condition, the WTRU may start monitoring the LP-WUS. The WTRU may continue to camp in the serving cell while performing the LP-WUS monitoring.

After starting to monitor the LP-WUS, the WTRU may perform the one or more measurements on the one or more sets of RSs (e.g., the LP-SSs) associated with the serving cell and one or more neighboring cells. For instance, the WTRU may perform the one or more measurements (e.g., the RSRP) on a 1^{st} set of LP-SSs associated with the serving cell and a 2^{nd} set of LP-SSs associated with the neighboring cell.

For determining the one or more adjustment factors for the LR measurement, the WTRU may determine the 1^{st} and 2^{nd} adjustment factors for the one or more LR measurements associated with the serving cell and the one or more neighboring cells.

In an example, for each cell (e.g., the serving cell and/or the neighboring cell etc.), the WTRU may determine a first adjustment factor (i.e. the delta) among the one or more preconfigured (e.g., preconfigured via the SI, the RRC signaling, the MAC-CE indication, and/or the DCI indication etc.) first adjustment factors based on the difference between the frequency bands of the MR and the LR of the cell.

If the MR frequency band is same as the LR frequency band, the WTRU may determine the first value (e.g., the first adjustment factor=0, i.e., no adjustment based on the frequency band).

If the MR frequency band—the LR frequency band>a first band difference threshold, the WTRU may determine a preconfigured (e.g., preconfigured the via the SI, the RRC signaling, the MAC-CE indication, and/or the DCI indication etc.) second value (e.g., a small adjustment) for the first adjustment factor

If the MR frequency band−LR frequency band>a second band difference threshold, the WTRU may determine the preconfigured (e.g., preconfigured via the SI, the RRC signaling, the MAC-CE indication, and/or the DCI indication etc.) third value (e.g., a large adjustment, i.e., third value>second value) for the first adjustment factor.

For each cell (e.g., serving cell, neighboring cell), the WTRU may determine a second adjustment factor (e.g., the alpha) among the one or more preconfigured (e.g., preconfigured via the SI, the RRC signaling, the MAC-CE indication, and/or DCI indication etc.) second adjustment factors based on the bandwidth radio between the MR and the LR of the cell.

If the MR bandwidth is same as the LR bandwidth, the WTRU may determine a first value (e.g., second adjustment factor=0, i.e., no adjustment based on bandwidth).

If the MR bandwidth to the LR bandwidth ratio (i.e., the MR bandwidth÷the LR bandwidth)>a first bandwidth ratio threshold, the WTRU may determine a preconfigured (e.g., preconfigured via the SI, the RRC signaling, the MAC-CE indication, and/or the DCI indication etc.) second value (e.g., a small adjustment) for the second adjustment factor.

If the MR bandwidth to the LR bandwidth ratio (i.e., the MR bandwidth÷the LR bandwidth)>a second bandwidth ratio threshold, the WTRU may determine a preconfigured (e.g., preconfigured via the SI, the RRC signaling, the MAC-CE indication and/or the DCI indication etc.) third value (e.g., the large adjustment) for the second adjustment factor.

For determining a cell based on the one or more adjusted LR measurements by the WTRU, the WTRU may determine the quality of two or more cells (e.g., the serving cell, the neighboring cell) based on the two or more measurements (e.g., the one or more measurements associated with the one or more configured RS sets (e.g., the LP-SSs)) associated with each cell and the one or more adjustment factors (e.g., the first adjustment factor (e.g. the delta) and the second adjustment factor (e.g. the alpha)). In an example, the WTRU may compute adjusted quality associated with each cell (e.g., the serving cell, the neighboring cell) by using one or more of the following:

$$Adjusted Quality = measured value + alpha \times delta \qquad equation ( 44 )$$

$$Adjusted Quality = alpha \times ( measured value + delta ) \qquad equation ( 45 )$$

$$Adjusted Quality = alpha \times ( measured value - delta ) \qquad equation ( 46 )$$

$$Adjusted Quality = measured value ( in dB ) + alpha ( in dB ) + delta ( in dB ) \qquad equation ( 47 )$$

$$Adjusted Quality = measured value ( in dB ) + alpha ( in dB ) - delta ( in dB ) \qquad equation ( 48 )$$

$$Adjusted Quality = measured value ( in dB ) - alpha ( in dB ) + delta ( in dB ) \qquad equation ( 49 )$$

$$Adjusted Quality = measured value ( in dB ) - alpha ( in dB ) - delta ( in dB ) \qquad equation ( 50 )$$

$$Adjusted Quality = alpha * measured value \qquad equation ( 51 )$$

$$Adjusted Quality = alpha + measured value \qquad equation ( 52 )$$

$$Adjusted Quality = measured value + delta \qquad equation ( 53 )$$

The WTRU may use the adjusted quality to determine the cell among the two or more cells for camping. To this end, the WTRU may compare the adjusted quality associated with the two or more cells (e.g., the adjusted quality of the serving cell, the adjusted quality of the neighboring cell). In an example configuration, when the WTRU performs measurements on the two or more cells (e.g., the serving cell, the neighboring cell), if the WTRU determines that the adjusted quality of the serving cell+preconfigured (e.g., via the SI, the RRC signaling, the MAC-CE indication, and/or the DCI indication etc.) offset≥adjusted quality of neighboring cell, the WTRU may continue to camp on the (current) serving cell. If the WTRU determines that the adjusted quality of serving cell+preconfigured offset<the adjusted quality of the neighboring cell, the WTRU may request to camp on the neighboring cell. In an example, the WTRU may wake-up the MR and transmit a request to the gNB (e.g., by transmitting a preconfigured (via the RRC signaling, the MAC-CE indication, and/or the DCI indication etc.) preamble on a PRACH resource, Msg1, MsgA). If the WTRU receives a confirmation from the gNB (e.g., via MsgB or Msg2 and Msg4, paging PDCCH, within a preconfigured (e.g., via the SI, the RRC signaling, the MAC-CE indication, the DCI indication) duration), the WTRU may camp on the neighboring cell. If the WTRU receives negative confirmation or no confirmation from the gNB, the WTRU may continue to camp on (current) serving cell at least for a preconfigured (e.g., via the SI, the RRC signaling, the MAC-CE indication, and/or the DCI indication etc.) duration before re-attempt to select a new cell to camp on while the LP-WUS monitoring.

In a solution, the WTRU may determine the cell for camping among the one or more cells (e.g., the serving and the neighboring cells) based on one or more of the LR measurement and the adjusted qualities. For instance, the WTRU may adjust the measured qualities of the sets of RSs associated with the serving cell and the neighboring cells based on the determined parameters. Based on the adjusted measured qualities, the WTRU may compare the adjusted measured qualities for the serving cell and the neighboring cell. For instance, the WTRU may determine the cell with highest adjusted measured qualities among the adjusted measured qualities. Based on the determination, the WTRU may camp on the determined cell.

In various embodiments, the adjustment of the LR measurements for determining the neighboring cell measurement relaxation based on the one or more bands for the MR and the LR is provided.

The WTRU receives the one or more configurations and/or the configuration information. The one or more configurations and/or the configuration information may be indicative of the two or more sets of RSs (e.g., the LP-SS) for two or more cells (e.g., the serving cell and the neighboring cells) wherein each set of RSs is associated with each cell.

The WTRU may receive (and/or the configuration may be indicative of) the MR threshold for the entry condition of the LP-WUS monitoring.

The WTRU may receive (and/or the configuration may be indicative of) the LR threshold for the exit condition of the LP-WUS monitoring

The WTRU may receive (and/or the configuration may be indicative of) the measurement relaxation threshold.

The WTRU may receive (and/or the configuration may be indicative of) the one or more first adjustment factors, e.g. the delta, wherein each adjustment factor is associated with one or more band differences between the MR band and the LR band.

The WTRU may receive (and/or the configuration may be indicative of) the one or more second adjustment factors, the alpha, wherein each adjustment factor is associated with the bandwidth ratio between the MR band and the LR band.

The WTRU may receive (and/or the configuration may be indicative of) the one or more band difference thresholds and/or the one or more bandwidth ratio thresholds.

The WTRU may activate the LP-WUS monitoring if the quality of the set of RSs (e.g., the serving cell) among the two or more sets>the MR threshold for entry condition.

The WTRU may perform the one or more measurements of the serving cell based on the set of RSs, associated with the serving cell, of the two or more sets of RSs.

The WTRU may determine the first adjustment factor among the one or more first adjustment factors based on the band difference between the MR and the LR.

In an example, if the MR band=the LR band, the WTRU determines the first value (e.g., 0).

In an example, if the MR band−the LR band>the first band difference threshold, the WTRU determines the second value (e.g., the small adjustment).

If the MR band−the LR band>the second band difference threshold, the WTRU determines the third value (e.g., the large adjustment).

The WTRU determines the second adjustment factor among the one or more second adjustment factors based on the bandwidth ratio between the MR and the LR in each cell.

If the MR bandwidth=the LR bandwidth band, the WTRU determines the first value (e.g., 0 (dB) if addition is used or 1 if multiplication is used).

If the MR band/LR band>the first bandwidth ratio threshold, the WTRU determines the second value (e.g., the small adjustment).

If the MR band−the LR band>the second bandwidth ratio threshold, the WTRU determines the third value (e.g., the large adjustment).

The WTRU may determine the quality of the two or more cells based on the measurements, the first adjustment factor and the second adjustment factor, for example:

$$Quality = measured value + alpha * delta \qquad equation ( 54 )$$

$$Quality = alpha * ( measured value + delta ) \qquad equation ( 55 )$$

$$Q uality = measured value + alpha + delta ( e . g . , in dB scale ) \qquad equation ( 56 )$$

In another example, the WTRU determines the adjusted threshold based on the configured measurement relaxation threshold, the first adjustment factor and the second adjustment factor, for example:

$$Adjusted measurement relaxation threshold = the configured measurement relaxation threshold + alpha * delta \qquad equation ( 57 )$$

$$Adjusted measurement relaxation threshold = alpha * ( the configured measurement relaxation threshold + delta \qquad equation ( 58 )$$

$$Adjusted measurement relaxation threshold = the configured measurement relaxation threshold + alpha + delta ( e . g . , in dB scale ) \qquad equation ( 59 )$$

$$Adjusted measurement relaxation threshold = alpha * configured measurement relaxation threshold \qquad equation ( 60 )$$

$$Adjusted measurement relaxation threshold = alpha + configured measurement relaxation threshold \qquad equation ( 61 )$$

$$Adjusted measurement relaxation threshold = configured measurement relaxation threshold + delta \qquad equation ( 62 )$$

The WTRU determines whether to relax the neighboring cell measurements based on the adjusted quality and the measurement relaxation threshold, for example:

If the adjusted measured quality>the configured measurement relaxation threshold, the WTRU is measuring only the serving cell.

If the measured quality>the adjusted measurement relaxation threshold, the WTRU is measuring only the serving cell.

Otherwise, the WTRU may perform the neighboring cell measurements.

In an example, the WTRU may receive one or more of (e.g., via one or more of the SIB, the RRC and/or the MAC CE etc.): the one or more configurations and/or the configuration information indicative of the LP-WUS monitoring and paging, the WTRU ID, the number of total paging frames, the number of paging occasions, the number of subgroups for the LP-WUS, the one or more offsets (e.g., paging frame offset and/or OFDM symbol offset).

The WTRU may receive the configuration of the one or more LOs and the MOs (e.g., based on the offset between the paging frame and the LO and/or the MO)

The WTRU may receive the two or more sets of RSs for the LR (e.g., the LP-SS) for the two or more cells (e.g., the serving cell and the neighboring cells etc.) wherein each set of the RSs is associated with each cell.

The WTRU may receive the two or more sets of RSs for the MR (e.g., the SSBs) for the two or more cells (e.g., the serving cell and the neighboring cells) wherein each set of RSs is associated with each cell.

The WTRU may receive the one or more candidate values for the alpha wherein each candidate value may be associated with the bandwidth ratio (e.g., bandwidth of NR/bandwidth of LR).

The WTRU may receive the one or more candidate values for the delta wherein each candidate value is associated with the band difference.

In an example, the WTRU may be configured and/or indicated and/or the WTRU may identify the set of band parameters related to the MR and the LR, respectively. For instance, the one or more cell IDs wherein each cell ID may be associated with one of the serving cell and the neighboring cells, the one or more band related parameters, and/or the list of carrier frequencies etc. may be configured.

The WTRU may be configured and/or indicated and/or the WTRU may identify the one or more bandwidths. For instance, the bandwidth for each band, bandwidth part, and/or carrier frequency may be configured.

The WTRU may be configured and/or indicated the one or more thresholds. For instance, the threshold for the entry condition (and/or activation) for the MR of the LP-WUS monitoring may be configured (e.g., in one or more of the RSRP, the RSRQ, and/or the RSSI etc.). In an example, the WTRU may receive the threshold for the exit condition (and/or deactivation) for the LR of the LP-WUS monitoring and/or may be configured (e.g., in the LP-RSRP, the LP-RSRQ, the LP-RSSI, the RSRP, the RSRQ, and/or the RSSI etc.) with the LR threshold. In an example, the WTRU may receive the one or more thresholds for measurement relaxation (e.g., for the MR and/or the LR) and/or the one or more thresholds may be configured.

In an example, the WTRU may measure the set of RSs for the MR associated with the serving cell.

In an example, the WTRU may determine whether to activate the LP-WUS monitoring and/or stop monitoring the POs. For instance, if one or more entry conditions are satisfied (e.g., channel quality of the MR based on the measurement of the set of RSs associated with the serving cell>the entry threshold for MR), the WTRU may start the LP-WUS monitoring in the one or more configured MOs and/or LOs associated with the WTRU.

In an example, the WTRU may determine one or more parameters (e.g., for adjusting the one or more thresholds and/or measured qualities). For example, the WTRU may determine the one or more adjustment parameters (e.g., the alpha) based on the bandwidth ratio between the MR and the LR bands and/or the band combinations.

The WTRU may be configured with the one or more candidate values wherein each candidate value may be associated with each band and/or band combination ratio between the MR and the LR.

One or more example candidate values based on the band difference between the MR and the LR are shown in Table 5:

TABLE 5

| | |
|---|---|
| Band difference between MR and LR | Candidate value |

| | | |
|---|---|---|
| <100 | MHz | Value 0 |
| <200 | MHz | Value 1 |
| <300 | MHz | Value 2 |
| <500 | MHz | Value 3 |
| <700 | MHz | Value 4 |
| <1 | GHz | Value 5 |

The WTRU may determine the one or more predefined candidate values wherein each candidate value may be associated with each band and/or band combination ratio difference between the MR and the LR.

The one or more adjustment parameters (e.g., the delta) may be determined based on the difference and/or the distance between the MR and the LR bands and/or the band combinations and/or the carrier frequencies.

The WTRU may be configured with the one or more candidate values wherein each candidate value may be associated with one or more bands and/or one or more band combination ratios between the MR and the LR.

The WTRU may determine the one or more predefined candidate values wherein each candidate value may be associated with the one or more bands and/or the one or more band combination ratios etc.

In an example, different bands and/or band combination ratios may be used for the different adjustment cases. For instance, if the WTRU adjusts the MR value for the LR band, then the WTRU may use the first bandwidth ratio (e.g., the first bandwidth ratio=MR bandwidth/LR bandwidth). If the WTRU adjusts the LR value for the MR band, then the WTRU may use the second bandwidth ratio (e.g., the second bandwidth ratio=LR bandwidth/MR bandwidth).

In an example, the different ranges of the bandwidth ratio and/or the candidate values may be used for different adjustment cases. For instance, if the WTRU adjusts the MR value for the LR band, then the WTRU may use the first set of ranges and the candidate values (e.g., shown in Table 3). If the WTRU adjusts the LR value for the MR band, then the WTRU may use the second set of ranges and the candidate values (e.g., shown in Table 4).

Example candidate values based on the bandwidth ratio between the MR and the LR are shown in Table 6.

TABLE 6

| Band ratio between MR and LR | |
|---|---|
| (e.g., LR band/MR band) | Candidate value |
| 1 | Value 0 |
| <1 | Value 1 |
| <0.75 | Value 2 |
| <0.5 | Value 3 |
| <0.25 | Value 4 |

Example candidate values based on the bandwidth ratio between the MR and the LR are shown in Table 7

TABLE 7

| Band ratio between MR and LR | |
|---|---|
| (e.g., MR band/LR band) | Candidate value |
| 1 | Value 0 |
| >1 | Value 1 |
| >2 | Value 2 |
| >3 | Value 3 |
| >5 | Value 4 |

In an example, the WTRU may determine the one or more measurement qualities and the one or more thresholds based on the determined one or more adjustment parameters. For instance, if the WTRU determines the one or more thresholds based on the determined one or more adjustment parameters, the one or more of the following methods may be used:

$$Adjusted threshold = configured entry threshold + alpha ( parameter based on bandwidth ratio ) * delta ( parameter based on band difference ) \qquad equation ( 63 )$$

$$Adjusted threshold = configured entry threshold + delta ( parameter based on band difference ) / \\ alpha ( parameter based on bandwidth ratio ) \qquad equation ( 64 )$$

$$Adjusted threshold = alpha * ( configured entry threshold + delta ) \qquad equation ( 65 )$$

$$Adjusted threshold = ( configured entry threshold + delta ) / alpha \qquad equation ( 66 )$$

$$Adjusted threshold = alpha * ( configured entry threshold - delta ) \qquad equation ( 67 )$$

$$Adjusted threshold = ( configured entry threshold - delta ) / alpha \qquad equation ( 68 )$$

$$Adjusted threshold = configured entry threshold + alpha + delta ( e . g . , in dB scale ) \qquad equation ( 69 )$$

$$Adjusted threshold = configured entry threshold + alpha - delta ( e . g . , in dB scale ) \qquad equation ( 70 )$$

$$Adjusted threshold = configured entry threshold - alpha + delta ( e . g . , in dB scale ) \qquad equation ( 71 )$$

$$Adjusted threshold = configured entry threshold - alpha - delta ( e . g . , in dB scale ) \qquad equation ( 72 )$$

In an example, if the WTRU determines the one or more measurements based on the determined one or more adjustment parameters, one or more of the following methods may be used:

$$Adjusted quality = measured quality + alpha ( parameter based on bandwidth ratio ) * delta ( parameter based on band difference ) \qquad equation ( 73 )$$

$$Adjusted quality = measured quality + delta ( parameter based on band difference ) / \\ alpha ( parameter based on bandwidth ratio ) \qquad equation ( 74 )$$

$$Adjusted quality = alpha * ( measured quality + delta ) \qquad equation ( 75 )$$

$$Adjusted quality = ( measured quality + delta ) / alpha \qquad equation ( 76 )$$

$$Adjusted quality = alpha * ( measured quality - delta ) \qquad equation ( 77 )$$

$$Adjusted quality = ( measured quality - delta ) / alpha \qquad equation ( 78 )$$

$$Adjusted quality = measured quality + alpha + delta ( e . g . , in dB scale ) \qquad equation ( 79 )$$

$$Adjusted quality = measured quality + alpha - delta ( e . g . , in dB scale ) \qquad equation ( 80 )$$

$$Adjusted quality = measured quality - alpha + delta ( e . g . , in dB scale ) \qquad equation ( 81 )$$

$$Adjusted quality = measured quality - alpha - delta ( e . g . , in dB scale ) \qquad equation ( 82 )$$

In an example, different adjustment equations may be used for different adjustment cases. For instance, if the WTRU adjusts the MR band values for the LR band, then the WTRU may use the first equation (e.g., adjusted threshold=alpha*(configured entry threshold+delta)). If the WTRU adjusts the LR value for the MR band, then the WTRU may use the second equation (e.g., adjusted threshold=(configured entry threshold-delta)/alpha).

In an example, the WTRU may measure the set of RSs for the LR (e.g., associated with the serving cell) among the two or more sets of RSs for the LR.

In an example, the WTRU may determine whether to relax the neighboring cell measurement based on the one or more of the LR measurements, the one or more thresholds for the measurement relaxation, the adjusted thresholds and the adjusted qualities. For instance, one or more of the following may be used:

For the measured quality based on the LR>adjusted threshold of the MR for the LR band, the WTRU may use the measured quality by measuring the set of RSs (e.g., one or more of the LP-SS and/or the one or more preambles of the LP-WUS etc.) associated with the serving cell for the LR measurement. If the measured quality for the serving cell>the adjusted measurement relaxation threshold of the MR for the LR band, then the WTRU may stop measuring the sets of RSs associated with the neighboring cells.

For the adjusted quality of the LR for the MR band >configured threshold of the LR, the WTRU may adjust the measured quality of the set of RSs associated with the serving cell based on the determined parameters. If the adjusted measured quality of the LR for the MR band >the configured measurement relaxation threshold for the MR band, then the WTRU may stop measuring the sets of RSs associated with the neighboring cells.

Otherwise, the WTRU may measure the sets of RSs associated with the neighboring cells (e.g., for the RRM measurement). In a solution, the sets of RSs may be for the LR measurement. In another solution, the sets of RSs may be for the MR measurement. In this case, the WTRU may activate the MR and measure the sets of RSs. After the measurement, the WTRU may deactivate the LR.

In various embodiments, the determination of the MR wake-up time based on the bands for the MR and the LR is provided. The WTRU may receive the one or more configurations and/or the configuration information (e.g., via the SIB). In that, the WTRU may receive the one or more configurations and/or the configuration information related to the LP-WUS monitoring and/or paging, the WTRU ID, the number of total paging frames, the number of paging occasions, the number of subgroups, the paging frame offset, the LO and/or the MO (e.g., based on the offset between the paging frame and the LO and/or the MO), the one or more RSs for the LR measurement, the one or more RSs for the MR (e.g., SSBs), the MR threshold for entry condition of the LP-WUS monitoring, and/or the LR threshold for the exit condition of the LP-WUS monitoring.

The WTRU may determine the candidate paging occasions based on the configurations related to the paging.

The WTRU may determine and/or report the one or more of the following parameters of the wake-up delays: the WTRU type (e.g., a first type WTRU (e.g., an independent LO with the MR) or a second type WTRU (e.g., a common LO with the MR), one or more band switching times if the WTRU is the second type WTRU.

In an example, each band switching time may be associated with one or more band differences.

The WTRU may start monitoring the LP-WUS in the one or more LOs and the one or more MOs based on the entry condition.

If the WTRU is the second type WTRU, the WTRU may determine the switching time based on the difference between the LP-WUS band and MR band.

The WTRU may receive the LP-WUS in the one or more monitored LOs and the MOs and stop the LP-WUS monitoring.

If the WTRU is the first type WTRU, the WTRU monitors the paging message in the first paging occasion of the candidate paging occasions after the ramp-up time associated with the one or more LOs and/or the MOs of the WTRU.

If the WTRU is the second type WTRU, the WTRU may monitor the paging message in the first paging occasion of the candidate paging occasions after the ramp-up time and the determined switching time associated with the one or more LOs and the MOs of the WTRU.

In an example, the WTRU may receive the configuration and/or the pre-configuration related to the LP-WUS monitoring and paging, e.g., through the SIB and/or the RRC signaling, including information such as the WTRU ID, the number of total paging frames, the number of paging occasions, the number of subgroups, the paging frame offset, the LO and/or the MO (e.g., based on offset between the paging frame and the LO and/or the MO) and the one or more RSs for the LR measurement. The WTRU may also receive the indications about the carrier, bands, frequencies and bandwidths of operation of the MR (e.g., cells and/or BWP) and of the LR.

In one solution, the WTRU may receive configuration and/or pre-configuration related to the LP-WUS monitoring and/or paging, e.g., through the SIB and/or the RRC signaling, including the one or more conditions to enable/disable or activate/deactivate the LP-WUS monitoring, based on the one or more MR and/or LR measurement thresholds.

In one option, the WTRU may receive the configuration of the one or more RSs to monitor using the MR for the one or more entry conditions (e.g., the SSB) and the associated threshold.

In one option, the WTRU may receive the configuration of the one or more RSs to monitor using the LR for the one or more exit conditions (e.g., the LP-SS) and the associated threshold.

In one solution, the WTRU may determine the candidate POs associated with the WTRU, e.g., based on the WTRU ID and based on the received configuration related to paging such as but not limited to the number of POs, the DRX cycle duration, and/or the paging frame configurations etc.

In an example, the WTRU may report to the network the one or more parameters about the wake-up delays, e.g., reported using the RRC configuration and/or reconfiguration, the MAC indication and/or WTRU capabilities. Multiple WTRU types may be configured and/or preconfigured and/or predefined, indicating the differences in how the WTRU processes the signals based on the WTRU implementation. For instance, if any part of a radio chain, hardware and/or processing needs an adjustment that introduces some delay when changing a functionality, e.g., when changing the receiving band, the bandwidth, and/or the modulation etc.

In one example, the first WTRU type may be for the one or more WTRUs when the local oscillator used for the LR is independent with the one used for the MR and the second WTRU type is where the local oscillator of the WTRU for the LR is common with the one MR. The local oscillators being band and/or bandwidth sensitive, the re-configuration of the band and/or the bandwidth of the operation may require a delay that needs to be included in the determination of the wake-up time.

In an example, the first WTRU type may be for the WTRUs when the WTRU is based on the OOK modulation and the second type may be when the LR is based on the OFDM modulation.

In one example, the WTRU type may be the band and/or the bandwidth specific, e.g., based on the configured MR and/or the LR bands and bandwidth. For instance, if the WTRU supports the reception of both the LR and the MR in a same band, the WTRU may be of the second type for that band, while being of the first type on a combination of bands where the WTRU does not support a common reception. This may be based on the frequency information received for the MR and LR operations.

The ramp-up time corresponds to the time needed by the WTRU to be able to receive correctly a MR signal-time to wake-up and resynchronize the WTRU. The ramp-up time may include at least a period duration of the SSB so that the WTRU is ensured to monitor the SS before receiving the PO.

The ramp-up time may be the band, the carrier, the cell and/or the BWP specific, e.g., based on the frequency information received for the MR and/or the LR operations. The ramp-up time may be different based on whether the LR and/or the MR share the same band and/or the bandwidth and/or radio processing and/or the hardware components, based on the implementation.

The WTRU may be of the second type (e.g., the local oscillator is common between LR and MR), the band switching time may be different for different band differences. The multiple switching time may be dependent on the band, the carriers, and/or the cells used for the MR and the LR. In some examples, which may be combined: the switching time values may be associated with one or more bandwidth differences. For instance, the bandwidth to monitor the LP-WUS may be smaller than the bandwidth of the MR band, the carrier, and/or the cell and/or the active DL BWP, and require the adjustment of the hardware of the WTRU to process the signals correctly after the wake-up. In one example, the LP-WUS monitoring is over 11 PRBs, while the MR cell is configured over 50 PRBs, so they have a 39 PRB of difference.

In some example, the WTRU may receive the configuration and/or the reconfiguration indicating a set bandwidth differences thresholds, and, for each threshold passed, an associated delta value.

The switching time values are each associated with a frequency difference between the MR and LR bands, the carriers, and/or the cells.

For example, the LP-WUS monitoring may be carried over the different band, carrier, and/or cell than the MR. The frequency distance between the bands, carriers, and/or cells may require some specific time adjustment for the hardware to process the signals correctly.

In an example, the WTRU may receive the configuration and/or the pre-configuration indicating the set frequency distance thresholds, and, for each threshold passed, an associated delta value. In one example, the frequency distance may be based on the center frequency of the LR band, carrier, cell, LOs, MOs and MR band, the carrier, the cell, and/or the BWP.

In one example, the WTRU may receive the configuration and/or the reconfiguration indicating a mapping between the combination of the LR and the MR bands, the carriers, the cells and the delta value. For instance, the first delta value may be associated with the first LR band and the first MR band; and the second delta value may be associated with the second LR band and the second MR band.

The switching time values may also be associated to the modulation of the LP-WUS, e.g., whether it is the same with the MR (e.g., both using the OFDM) or whether it is different (e.g., the LP-WUS being based on OOK modulation). These parameters may be explicitly reported and/or reported as a group of parameters related to, e.g., one in a list of the configured and/or the preconfigured set of parameters. For instance, as the set from the WTRU capabilities. In an example, the WTRU may receive the configuration and/or the indication (e.g., via the RRC signaling, the MAC-CE indication, the DCI indication and/or the SI etc.) to start monitoring the LP-WUS.

The WTRU may receive a RRC release message indicating to activate the LP-WUS monitoring.

In another example, the WTRU may determine to monitor the LP-WUS, based on the configured entry condition of the LP-WUS monitoring and the corresponding MR measurements. For instance, if the MR measurement (e.g., based on the received configuration of RS (e.g., the SSB and/or the CSI-RS etc.) measurement of the serving cell) is higher than the configured entry condition threshold, the WTRU may turn off the MR and start monitoring for the LP-WUS using the LR.

In a solution, the WTRU may determine the total wake-up time for when the WTRU receives the wake-up indication in the LP-WUS, adding both the ramp-up delay and the band switching delay, based on the reported WTRU type, the ramp-up delay and the band switching delay. For example, if the WTRU is the first type WTRU, the WTRU determines a total wake-up time being the ramp-up time of the corresponding band, carrier, and/or the cell etc.

If the WTRU is the second type WTRU, the WTRU determines the total wake-up time being the ramp-up time plus the determined switching time associated based on the band, and/or bandwidth difference of the LR and MR operations.

In one solution, the WTRU may determine the one or more monitoring occasions for the LR, e.g., the LOs and MOs, and their association with the determined POs, including the total wake-up time as the minimum delay between the LO and/or the MO and the associated PO.

In one example, based on the one or more determined POs, the WTRU may determine the one or more LOs. For instance, the LO may be associated with each PO (e.g., based on time and/or frequency offset). The WTRU may determine the LO which is associated with the determined PO (e.g., based on the WTRU ID), for which the offset between the LO and PO is greater than the total wake-up time.

The WTRU may then start monitoring for the LP-WUS in the one or more configured LOs and/or MOs, e.g., until the WTRU receives a wake-up indication in one of such LO/MO, the LR measurement passes the exit condition threshold, or any configured condition for which the WTRU stops monitoring the LP-WUS.

In a solution, the WTRU may determine the band switching time value to use, based on the LR and/or MR frequency operation information, for the types of the WTRU that are indicated to need the band switching time, e.g., the second WTRU type.

In one example, the WTRU receives the configuration associated with the LR and MR frequency operations being in the same band, and for that band, the WTRU is configured and/or the reconfigured to be of the second WTRU type. The WTRU may determine and/or select, from the set of band switching times reported to the network and based on the associated band and/or bandwidth difference, the corresponding band switching time.

In one example, the WTRU may reselect and/or re-determine the band switching time based on the received updates and/or reconfiguration of the LR and/or the MR operation frequency information, e.g., from the SIB, the RRC, the MAC and/or the DCI signaling etc.

The WTRU may then receive the indication in the LP-WUS indicating the WTRU may wake-up and prepare to monitor the PDCCH using the MR, and may stop monitoring the LP-WUS, e.g., based on the indicated WTRU ID, group ID, subgroup ID etc. in the LP-WUS monitored in the LO and/or the MO.

In an example, the WTRU may monitor the paging message in the first paging occasion of the candidate paging occasions after the total wake-up time. In that, if the WTRU is the first type WTRU, the WTRU may monitor the paging message in a first paging occasion of the one or more candidate paging occasions after the ramp-up time associated with the one or more LOs and/or MOs of the WTRU.

If the WTRU is the second type WTRU, the WTRU may monitor the paging message in the first paging occasion of the one or more candidate paging occasions after the ramp-up time and the determined switching time associated with the one or more LOs and the MOs of the WTRU.

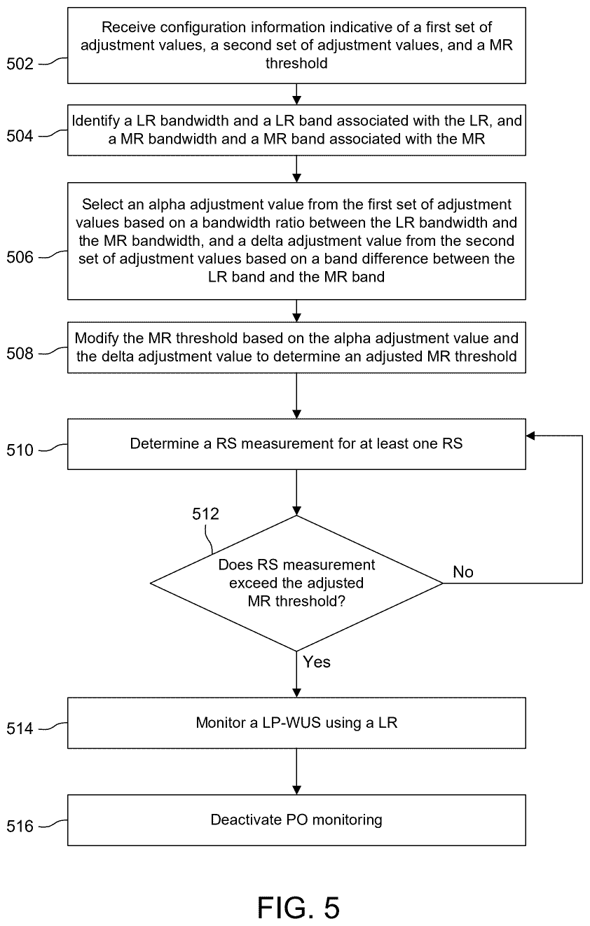

FIG. 5 is a flowchart illustrating an example process for monitoring the LP-WUS according to one or more embodiments. The process may be used in the WTRU.

At 502, the WTRU receives the configuration information indicative of the first set of adjustment values, the second set of adjustment values, and the MR threshold. In that, the WTRU may receive (e.g., the SIB etc.), the configuration information (e.g., the one or more configurations) related to the LP-WUS monitoring and/or paging, the WTRU ID, the number of total paging frames, the number of POs, the number of subgroups, the paging frame offset, the one or more LOs and/or MOs (e.g., based on the offset between a paging frame and the LO and/or the MO), the one or more RSs for the LR measurement, the one or more RSs for the MR measurement (e.g., one or more SSBs etc.), at least one MR threshold for at least one entry condition associated with the LP-WUS monitoring, at least one LR threshold for at least one exit condition associated with the LP-WUS monitoring, one or more candidate values (e.g., the first set of adjustment values) for the alpha adjustment parameter (also simply referred to as “alpha”) wherein each candidate value (e.g. one or more first adjustment values from the first set of adjustment values) is associated with one or more bandwidth ratios (e.g., the ratio of bandwidth of the MR/the bandwidth of LR), and/or one or more candidate values (e.g., the second set of candidate values) for the delta adjustment parameter (also simply referred to as “delta”) wherein each candidate value (e.g. one or more second adjustment values form the second set of adjustment values) is associated with one or more band differences between the LR band (e.g., the LP-WUS band) and the MR band.

At 504, the WTRU identifies the LR bandwidth and the LR band associated with the LR. The WTRU also identifies the MR bandwidth and the MR band associated with the MR. In that, the WTRU may identify the one or more band parameters related to the MR and/or the LR, respectively. Examples of the one or more band parameters include but are not limited to the band, the carrier frequency, and/or the bandwidth etc.

At 506, the WTRU selects the alpha adjustment value from the first set of adjustment values based on the bandwidth ratio between the LR bandwidth and the MR bandwidth. The WTRU selects the delta adjustment value from the second set of adjustment values based on the band difference between the LR band and the MR band. In an example, different ranges of bandwidth ratios and/or candidate values may be used for different adjustment cases. For instance, if the WTRU adjusts the MR value for the LR band, then the WTRU may use the first set of ranges and/or candidate values (e.g., shown in Table 3). If the WTRU adjusts the LR value for the MR band, then the WTRU may use the second set of ranges and candidate values (e.g., shown in Table 4).

At 508, the WTRU modifies the MR threshold based on the alpha adjustment value and the delta adjustment value to determine the adjusted MR threshold. In that, different adjustment equations may be used for different adjustment cases. For instance, if the WTRU adjusts the MR band values for the LR band, then the WTRU may use the first equation (e.g., adjusted threshold=alpha*(configured entry threshold+delta)). In an example, if the WTRU adjusts LR value for the MR band, then the WTRU may use the second equation (e.g., adjusted threshold=(configured entry threshold-delta)/alpha) etc.

At 510, the WTRU determines the RS measurement for at least one RS.

At 512, the WTRU checks whether the RS measurement exceeds threshold.

At 514, if the RS measurement exceeds the threshold at 512, the WTRU monitors the LP-WUS using the LR.

At 516, the WTRU deactivates the PO monitoring.

If the RS measurement does not exceed or is equal to the threshold at 512, the WTRU continues the PO monitoring.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU), comprising:
at least one transceiver comprising:
a low power radio (LR); and
a main radio (MR);
a memory; and
a processor, wherein the processor and the at least one transceiver are configured to:
receive configuration information indicative of a first set of adjustment values,
a second set of adjustment values, and a MR threshold,
identify a LR bandwidth and a LR band associated with the LR,
identify a MR bandwidth and a MR band associated with the MR,
select an alpha adjustment value from the first set of adjustment values based on a bandwidth ratio between the LR bandwidth and the MR bandwidth,
select a delta adjustment value from the second set of adjustment values based on a band difference between the LR band and the MR band,
modify the MR threshold based on the alpha adjustment value and the delta adjustment value to determine an adjusted MR threshold,
determine that a reference signal (RS) measurement for at least one RS exceeds the adjusted MR threshold, and
monitor a low power (LP)-wakeup signal (WUS) using the LR based on the determination.

2. The WTRU of claim 1, wherein the processor and the at least one transceiver are further configured to:
monitor one or more paging occasions (POs), and
receive one or more RSs including the at least one RS in the one or more POs.

3. The WTRU of claim 2, wherein the processor and the at least one transceiver are further configured to:
on a condition that the RS measurement exceeds the adjusted MR threshold,
deactivate monitoring the one or more POs.

4. The WTRU of claim 3, wherein the configuration information is further indicative of an LR threshold.

5. The WTRU of claim 4, wherein the processor and the at least one transceiver are further configured to:
modify the LR threshold based on the alpha adjustment value and the delta adjustment value to determine an adjusted LR threshold,
determine a LP-RS measurement for at least one LP-RS, and
on a condition that the LP-RS measurement exceeds the adjusted LR threshold,
deactivate monitoring the LP-WUS, and
monitor the one or more POs.

6. The WTRU of claim 5, wherein the processor and the at least one transceiver are further configured to:
modify the RS measurement based on the alpha adjustment value and the delta adjustment value to determine an adjusted RS measurement, and
on a condition that the adjusted RS measurement exceeds the MR threshold,
monitor the LP-WUS using the LR.

7. The WTRU of claim 6, wherein the processor and the at least one transceiver are further configured to:
modify the LP-RS measurement based on the alpha adjustment value and the delta adjustment value to determine an adjusted LP-RS measurement, and
on a condition that the adjusted LP-RS measurement exceeds the LR threshold,
deactivate monitoring the LP-WUS, and
monitor the one or more POs.

8. The WTRU of claim 7, wherein at least one of the LP-RS measurement or the RS measurement comprises one or more of:
a RS received power (RSRP) or a LP-RSRP,
a RS received quality (RSRQ) or a LP-RSRQ,
a RS received strength indicator (RSSI) or a LP-RSSI,
a synchronization signal (SS) or a LP-SS, or
a preamble of the LP-WUS.

9. The WTRU of claim 1, wherein the alpha adjustment value is zero when the LR bandwidth and the MR bandwidth are same.

10. The WTRU of claim 1, wherein the delta adjustment value is zero when the band difference between the LR band and the MR band is less than a band difference threshold.

11. The WTRU of claim 1, wherein at least one of the alpha adjustment value or the delta adjustment value is measured on a decibel (dB) scale.

12. A method for use in a wireless transmit/receive unit (WTRU), the method comprising:
receiving configuration information indicative of a first set of adjustment values, a second set of adjustment values, and a main radio (MR) threshold;
identifying a low power radio (LR) bandwidth and a LR band associated with the LR;
identifying a MR bandwidth and a MR band associated with the MR;
selecting an alpha adjustment value from the first set of adjustment values based on a bandwidth ratio between the LR bandwidth and the MR bandwidth;
selecting a delta adjustment value from the second set of adjustment values based on a band difference between the LR band and the MR band;
modifying the MR threshold based on the alpha adjustment value and the delta adjustment value to determine an adjusted MR threshold;
determining a reference signal (RS) measurement for at least one RS;
on a condition that the RS measurement exceeds the adjusted MR threshold,
monitoring a low power (LP)-wakeup signal (WUS) using the LR; and
on a condition that the RS measurement does not exceed or is equal to the adjusted MR threshold,
monitoring one or more paging occasions (POs) for receiving one or more RSs.

13. The method of claim 12, further comprising:
on the condition that the RS measurement exceeds the adjusted MR threshold,
deactivating monitoring the one or more POs.

14. The method of claim 13, wherein the configuration information is further indicative of an LR threshold.

15. The method of claim 14, further comprising:
modifying the LR threshold based on the alpha adjustment value and the delta adjustment value for determining an adjusted LR threshold;
determining a LP-RS measurement for at least one LP-RS; and
on a condition that the LP-RS measurement exceeds the adjusted LR threshold,
deactivating monitoring the LP-WUS; and
monitoring the one or more POs.

16. The method of claim 15, further comprising:
modifying the RS measurement based on the alpha adjustment value and the delta adjustment value to determine an adjusted RS measurement; and
on a condition that the adjusted RS measurement exceeds the MR threshold,
monitoring the LP-WUS using the LR.

17. The method of claim 16, further comprising:
modifying the LP-RS measurement based on the alpha adjustment value and the delta adjustment value to determine an adjusted LP-RS measurement; and
on a condition that the adjusted LP-RS measurement exceeds the LR threshold,
deactivating monitoring the LP-WUS; and
monitoring the one or more POs.

18. The method of claim 17, wherein at least one of the LP-RS measurement or the RS measurement comprises one or more of:
a RS received power (RSRP) or a LP-RSRP,
a RS received quality (RSRQ) or a LP-RSRQ,
a RS received strength indicator (RSSI) or a LP-RSSI,
a synchronization signal (SS) or a LP-SS, or
a preamble of the LP-WUS.

19. The method of claim 12, wherein the alpha adjustment value is zero when the LR bandwidth and the MR bandwidth are same.

20. The method of claim 12, wherein the delta adjustment value is zero when the band difference between the LR band and the MR band is less than a band difference threshold.
